(19) United States
(12) Patent Application Publication
(10) Pub. No.: US 2005/0225003 A1
(43) Pub. Date: Oct. 13, 2005

(54) Method for producing washing and cleaning agents in the form of filled moulded bodies II

(76) Inventors: Thomas Holderbaum, Monheim (DE); Bernd Richter, Leichlingen (DE); Wolfgang Barthel, Langenfeld (DE)

Correspondence Address: HENKEL CORPORATION, THE TRIAD, SUITE 200, 2200 RENAISSANCE BLVD., GULPH MILLS, PA, 19406, US

(21) Appl. No.: 11/134,224

(22) Filed: May 20, 2005

Related U.S. Application Data
(63) Continuation of application No. PCT/EP03/12624, filed on Nov. 12, 2003.

(30) Foreign Application Priority Data
Nov. 21, 2002 (DE) 102 54 314.3

(51) Int. Cl. B27N 3/00

(52) U.S. Cl. 264/109

(57) ABSTRACT

A process of making detergent tablets by forming a basic tablet cavity, filling the cavity with an appropriate detergent material, and the cavity with a film that forms part of a label wrapping the tablet.

### CROSS REFERENCE TO RELATED APPLICATIONS

This application is a continuation under 35 U.S.C. § 365(c) and 35 U.S.C. § 120 of international application PCT/EP2003/012624, filed on Nov. 12, 2003. This application also claims priority under 35 U.S.C. § 119 of DE 102 54 314.3, filed Nov. 21, 2002, which is incorporated herein by reference in its entirety.

### BACKGROUND OF THE INVENTION

This invention relates to a process for the production of filled and subsequently sealed detergent tablets. More particularly, the invention relates to a process for the production of filled detergent tablets comprising a basic tablet with a recess which is filled and sealed.

Supply forms for detergents in which various active components are located in different regions have recently been found to offer advantages. Starting from the two-layer tablet or multi-compartment bags, the literature describes various hybrid forms where tablets are combined with other bodies or where water-soluble or water-dispersible packs are filled with tablets and/or other forms of preparation. One possible option in this respect is the provision of a basic tablet (for example a tablet with a recess or hole, a thermoformed molding of water-soluble material, an injection molding of water-soluble material, etc.) which is filled and then sealed, the sealing step playing an important role in the case of molds of polymers.

However, the mass production of filled and sealed tablets involves problems. Thus, the filled tablets are difficult to move without the filling partly escaping and interfering with the application of adhesion promoters or the adhesion of the sealing film to the edges of the tablet. In addition, the application of adhesives to the edges of the basic tablet is problematical where the filling is introduced before application of the adhesive because the filling can contaminate the tools used for application.

Shaped bodies or tablets where both temperature- and pressure-sensitive ingredients can be introduced into defined regions—the defined region being unlimited in its size relative to the shaped body as a whole and, in addition, an optical differentiation in relation to conventional two-layer tablets being achieved—are disclosed in German patent application DE 199 32 765 A1 (Henkel KGaA). This document also discloses a production process for the filled tablets.

However, in this case, too, mass production is attended by the problems just described. Thus, the filled tablets are difficult to move without the filling partly leaking onto the top of the tablet and interfering with the application of adhesion promoters or the adhesion of the film. In addition, the application of adhesives to the tablet surface is problematical where the filling is introduced before application of the adhesive because the filling can contaminate the tools used for application. Another problem lies in the exact cutting to size of the film after application because projecting film borders spoil the appearance of the tablet.

The problem addressed by the present invention was to provide a mass production process for filled tablets of the type mentioned at the beginning which would be free from the disadvantages mentioned.

The present invention relates to a process for the production of detergent tablets by
a) producing an open shaped body (“basic tablet”) comprising at least one cavity;
b) filling the cavity(ies) with one or more active substances in liquid, gel, paste or solid form,
c) sealing the openings of the (filled) cavities with a film,
   in which labels matching the size of the surface of the basic tablet are punched out from the film and firmly held by vacuum, after which the labels are applied to the tablet.

According to the invention, a fillable basic tablet is first produced and then filled and sealed. The fillable basic tablet may advantageously be produced from materials which perform a function in the washing or cleaning process, the tabletting of active-substance mixtures playing a prominent role. However, greater dimensional variability can be achieved by using materials that do not perform any specific function in the washing or cleaning process. Water-soluble or water-dispersible polymers are of particular importance in this regard. The disadvantage that additional “ballast” is used is offset by the advantage of greater variability in shape and possible ingredients and by a considerable aesthetic impact.

Accordingly, preferred variants of the process according to the invention are characterized in that the production of the basic tablet in step a) comprises the tabletting of a particulate premix to form a tablet (basic tablet) which has at least one cavity.

Another preferred embodiment are processes according to the invention which are characterized in that the production of the basic tablet in step a) is carried out by thermoforming and/or casting and/or injection moulding and/or blow molding of a water-soluble or water-dispersible polymer or polymer mixture.

In another preferred embodiment, the production of the basic tablet in step a) is carried out by casting a dispersion of solid particles in a dispersion medium. This dispersion preferably contains
i) 10 to 65% by weight of dispersion medium and
ii) 30 to 90% by weight of dispersed solids,
   based on its total weight.

In the context of the present invention, a dispersion is understood to be a system of several phases of which one is continuous (dispersion medium) and at least one other is finely dispersed (dispersed solids).

Particularly preferred detergents according to the invention are characterized in that they contain the dispersion medium in quantities above 11% by weight, preferably in quantities above 13% by weight, more preferably in quantities above 15% by weight, most preferably in quantities above 17% and, in one most particularly preferred embodiment, in quantities above 19% by weight, based on the total weight of the dispersion. Other preferred detergents according to the invention comprise a dispersion with a percentage by weight of dispersion medium above 20% by weight, preferably above 21% by weight and, more particularly, above 22% by weight, based on the total weight of the dispersion. The maximum dispersion medium content of preferred dispersions according to the invention, based on the total weight of the dispersion, is less than 63% by weight, preferably less than 57% by weight, more preferably less than 52% by weight, most preferably less than 47% by weight and, in one most particularly preferred embodiment, less than 37% by weight. According to the invention, particularly preferred detergents contain dispersion medium in quantities of 12 to 62% by weight, preferably in quantities of 17 to 49% by weight and more particularly in quantities of 23 to 38% by weight, based on the total weight of the detergent.

Dispersions with a density above 1.040 g/cm³ are preferred. In a most particularly preferred embodiment, the dispersions according to the invention have a density of 1.040 to 1.670 g/cm³, preferably in the range from 1.120 to 1.610 g/cm³, more preferably in the range from 1.210 to 1.570 g/cm³, most preferably in the range from 1.290 to 1.510 g/cm³ and more especially in the range from 1.340 to 1.480 g/cm³. The density figures are the densities of the dispersions at 20° C.

The dispersion media used are preferably soluble or dispersible in water. The solubility of these dispersion media at 25° C. is more than 200 g/l, preferably more than 300 g/l, more preferably more than 400 g/l, most preferably between 430 and 620 g/l and more especially between 470 and 580 μl.

Dispersions preferably used in accordance with the invention are distinguished by the fact that they dissolve in water (40° C.) in less than 12 minutes, preferably in less than 10 minutes, more preferably in less than 9 minutes, most preferably in less than 8 minutes and more especially in less than 7 minutes. To determine solubility, 20 g of the dispersion are introduced into the interior of a dishwasher (Miele G 646 PLUS). The main wash cycle of a standard dishwashing program (45° C.) is started. Solubility is determined by measuring conductivity which is recorded via a conductivity sensor. The dissolving process is complete when maximum conductivity is reached. In the conductivity graph, this maximum corresponds to a plateau. The conductivity measurement begins with the actuation of the circulation pump in the main wash cycle. The quantity of water used amounts to 5 liters.

According to the invention, preferred dispersion media are water-soluble or water-dispersible polymers, more particularly water-soluble or water-dispersible nonionic polymers. The dispersion medium may be both a single polymer and mixtures of different water-soluble or water-dispersible polymers. In another preferred embodiment of the present invention, the dispersion medium or at least 50% by weight of the polymer mixture consists of water-soluble or water-dispersible nonionic polymers from the group of polyvinyl pyrrolidones, vinyl pyrrolidone/vinyl ester copolymers, cellulose ethers, polyvinyl alcohols, polyalkylene glycols, more particularly polyethylene glycol and/or polypropylene glycol.

Suitable polyalkylene glycols are, in particular, polyethylene glycols and polypropylene glycols. Polymers of ethylene glycol which correspond to general formula (III):
H—(O—CH₂—CH₂)ₙ—OH (III)
where n may assume values of 1 (ethylene glycol) to several thousand. Various nomenclatures are used for polyethylene glycols which can lead to confusion. It is common practice to indicate the mean relative molecular weight after the initials “PEG”, so that “PEG 200” characterizes a polyethylene glycol having a relative molecular weight of about 190 to about 210. Cosmetic ingredients are covered by another nomenclature in which the initials PEG are followed by a hyphen and the hyphen is in turn directly followed by a number which corresponds to the index n in general formula VII above. Under this nomenclature (so-called INCI nomenclature, CTFA International Cosmetic Ingredient Dictionary and Handbook, 5th Edition, The Cosmetic, Toiletry and Fragrance Association, Washington, 1997), PEG-4, PEG-6, PEG-8, PEG-9, PEG-10, PEG-12, PEG-14 and PEG-16, for example, may be used. Polyethylene glycols are commercially obtainable, for example, under the names of Carbowax® PEG 200 (Union Carbide), Emkapol® 200 (ICI. Americas), Lipoxol® 200 MED (HOLS America), Polyglycol® E-200 (Dow Chemical), Alkapol® PEG 300 (Rhone-Poulenc), Lutrol® E300 (BASF) and the corresponding commercial names with higher numbers. The average relative molecular weight of at least one of the dispersion media, more particularly of at least one of the poly(alkylene)glycols, used in the detergents according to the invention is preferably in the range from 200 to 36,000, more preferably in the range from 200 to 6,000 and most preferably in the range from 300 to 5,000.

Polypropylene glycols (PPGs for short) are polymers of propylene glycol which correspond to general formula (IV): 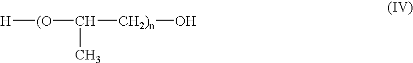
where n may assume a value of 1 (propylene glycol) to several thousand. Di-, tri- and tetrapropylene glycol, i.e. representatives where n=2, 3 and 4 in formula IV, are of particular commercial significance.

Particularly preferred detergents according to the invention contain as dispersion medium a nonionic polymers, preferably a poly(alkylene)glycol and more preferably a poly(ethylene)glycol and/or a poly(propylene)glycol, the percentage contribution by weight of the poly(ethylene)glycol to the total weight of all dispersion media preferably being between 10 and 90% by weight, more preferably between 30 and 80% by weight and most preferably between 50 and 70% by weight. Particularly preferred detergents according to the invention are characterized in that more than 92% by weight, preferably more than 94% by weight, more preferably more than 96% by weight, most preferably more, than 98% by weight and more particularly 100% by weight of the dispersion medium consists of a poly(alkylene)glycol, preferably poly(ethylene)glycol and/or poly(propylene)glycol, but especially poly(ethylene)glycol. Dispersion media which, besides poly(ethylene)glycol, also contain poly(propylene)glycol, preferably have a ratio by weight of poly(ethylene)glycol to poly(propylene)glycol of 40:1 to 1:2, preferably 20:1 to 1:1, more preferably 10:1 to 1.5:1 and more particularly 7:1 to 2:1.

Other preferred dispersion media are nonionic surfactants which may be used both individually and—preferably—in combination with a nonionic polymer. A detailed description of suitable nonionic surfactants can be found further on in the specification. Reference is made here to that description in order to avoid repetitions.

Particularly preferred detergents according to the invention contain at least one nonionic surfactant, preferably at least one end-capped poly(alkoxylated) nonionic surfactant, as dispersion medium, the percentage contribution by weight of the nonionic surfactant to the total weight of all dispersion media preferably being between 1 and 60% by weight, more preferably between 2 and 50% by weight and most preferably between 3 and 40% by weight. Particularly preferred detergents according to the invention are characterized in that the percentage contribution by weight of the nonionic surfactant(s) to the total weight of the detergent according to the invention is between 0.5 and 40% by weight, preferably between 1 and 30% by weight, more preferably between 2 and 25% by weight and more particularly between 2.5 and 23% by weight.

Preferred detergents according to the invention are characterized in that at least one dispersion medium has a melting point above 25° C., preferably above 35° C. and more particularly above 40° C. Thus, these detergents may contain, for example, a dispersion medium with a melting point above 26° C. or above 30° C. or 35° C. or above 42° C. or above 50° C. It is particularly preferred to use dispersion media with a melting point or melting range of 30 to 80° C., preferably 35 to 75° C., more preferably 40 to 70° C. and most preferably 45 to 65° C., these dispersion media making a percentage contribution by weight to the total weight of the dispersion media used of more than 10% by weight, preferably more than 40% by weight, more preferably more than 70% by weight and most preferably between 80 and 100% by weight.

Preferred detergents according to the invention are dimensionally stable at 20° C. Dimensionally stable detergents according to the invention have an intrinsic dimensional stability which enables them to assume a non-disintegrating three-dimensional form under the usual conditions of production, storage, transportation and handling by the consumer, this three-dimensional form remaining unchanged for a prolonged period, preferably for 4 weeks, more preferably for 8 weeks and more particularly for 32 weeks, under those conditions, i.e. staying in the geometric three-dimensional form in which they are produced, i.e. not deliquescing, under the usual conditions of production, storage, transportation and handling by the consumer.

In another preferred embodiment, the detergents according to the invention contain at least one dispersion medium with a melting point below 15° C., preferably below 12° C. and more particularly below 8° C. Particularly preferred dispersion media have a melting range of 2 to 14° C. and more particularly of 4 to 10° C.

Dispersed substances in the context of the present invention are any detersive substances solid at room temperature, but especially detersive substances from the group of builders and cobuilders, detersive polymers, bleaching agents, bleach activators, glass corrosion inhibitors, silver protectors and/or enzymes.

Preferred detergents according to the invention are characterized in that, based on their total weight, the dispersed substances contain at least 20% by weight, preferably at least 30% by weight, more preferably at least 40% by weight and most preferably at least 50% by weight of builders and/or bleaching agents and/or bleach activators and/or detersive polymers and/or glass corrosion inhibitors and/or silver protectors and/or enzymes. Detergents of which at least 90% by weight, preferably at least 92% by weight, more preferably at least 94% by weight, most preferably at least 96% by weight, more particularly at least 98% by weight and, in a most particularly preferred embodiment, at least 99.5% by weight consists solely of builders and/or bleaching agents and/or bleach activators and/or detersive polymers and/or glass corrosion inhibitors and/or silver protectors and/or enzymes besides the preferred dispersion media mentioned above represent particularly preferred detergents according to the invention.

Irrespective of the method used to produce the fillable tablets, basic tablets comprising at least one cavity are produced in the first step of the process according to the invention. The basic tablets according to the invention may also be designed to have several cavities which are successively or simultaneously filled with the same active substances or with different active substances.

Step a) of the preferred variant of the process for the production of cavity tablets is described in the following:

It has proved to be of advantage if the premix compressed to form basic tablets in step a) satisfies certain physical criteria. Preferred processes are characterized, for example, in that the particulate premix in step a) has a bulk density of at least 500 g/l, preferably of at least 600 g/l and more preferably of at least 700 g/l.

The particle size of the premix tabletted in step a) also preferably satisfies certain criteria. According to the invention, preferred processes are characterized in that the particulate premix in step a) has particle sizes of 100 to 2000 μm, preferably in the range from 200 to 1800 μm, more preferably in the range from 400 to 1600 μm and most preferably in the range from 600 to 1400 μm. A narrower particle size range in the premixes to be tabletted may be adjusted in order to acquire advantageous tablet properties. In preferred variants of the process according to the invention, the particulate premix tabletted in step a) has a particle size distribution where less than 10% by weight, preferably less than 7.5% by weight and more preferably less than 5% by weight of the particles are larger than 1600 μm or smaller than 200 μm. Narrower particle size distributions are even more preferred. Particularly advantageous variants of the process are characterized in that the particulate premix tabletted in step a) has a particle size distribution where more than 30% by weight, preferably more than 40% by weight and more preferably more than 50% by weight of the particles have a particle size of 600 to 1000 μm.

Step a) of the process according to the invention is not confined to compressing just one particulate premix to form a tablet. Instead, process step a) may also be augmented to the extent that multilayer tablets are produced in known manner by preparing two or more premixes which are pressed onto one another. In this case, the first premix introduced is lightly precompressed in order to obtain a smooth upper surface running parallel to the base of the tablet and, after the second premix has been introduced, the whole is compressed to form the final tablet. In the case of tablets with three or more layers, each addition of premix is followed by further precompression before the tablet is compressed for the last time after addition of the last premix. The above-described cavity in the basic tablet is preferably a recess so that preferred embodiments of the first process according to the invention are characterized in that multilayer tablets comprising a recess are produced in known manner in step a) by pressing several different particulate premixes onto one another.

The tablets according to the invention are produced in step a) by first dry-mixing the ingredients—which may be completely or partly pregranulated—and then shaping/forming, more particularly tabletting, the resulting mixture using conventional processes. To produce the tablets according to the invention, the premix is compacted between two punches in a die to form a solid compactate. This process, which is referred to in short hereinafter as tabletting, comprises four phases, namely metering, compacting (elastic deformation), plastic deformation and ejection.

The premix is first introduced into the die, the filling level and hence the weight and shape of the tablet formed being determined by the position of the lower punch and the shape of the die. Uniform dosing, even at high tablet throughputs, is preferably achieved by volumetric dosing of the premix. As the tabletting process continues, the top punch comes into contact with the premix and continues descending towards the bottom punch. During this compaction phase, the particles of the premix are pressed closer together, the void volume in the filling between the punches continuously diminishing. The plastic deformation phase in which the particles coalesce and form the tablet begins from a certain position of the top punch (and hence from a certain pressure on the premix). Depending on the physical properties of the premix, its constituent particles are also partly crushed, the premix sintering at even higher pressures. As the tabletting rate increases, i.e. at high throughputs, the elastic deformation phase becomes increasingly shorter so that the tablets formed can have more or less large voids. In the final step of the tabletting process, the tablet is forced from the die by the bottom punch and carried away by following conveyors. At this stage, only the weight of the tablet is definitively established because the tablets can still change shape and size as a result of physical processes (re-elongation, crystallographic effects, cooling, etc.).

The tabletting process is carried out in commercially available tablet presses which, in principle, may be equipped with single or double punches. In the latter case, not only is the top punch used to build up pressure, the bottom punch also moves towards the top punch during the tabletting process while the top punch presses downwards. For small production volumes, it is preferred to use eccentric tablet presses in which the punch(es) is/are fixed to an eccentric disc which, in turn, is mounted on a shaft rotating at a certain speed. The movement of these punches is comparable with the operation of a conventional four-stroke engine. Tabletting can be carried out with a top punch and a bottom punch, although several punches can also be fixed to a single eccentric disc, in which case the number of die bores is correspondingly increased. The throughputs of eccentric presses vary according to type from a few hundred to at most 3,000 tablets per hour.

For larger throughputs, rotary tablet presses are generally used. In rotary tablet presses, a relatively large number of dies is arranged in a circle on a so-called die table. The number of dies varies—according to model—between 6 and 55, although even larger dies are commercially available. Top and bottom punches are associated with each die on the die table, the tabletting pressures again being actively built up not only by the top punch or bottom punch, but also by both punches. The die table and the punches move about a common vertical axis, the punches being brought into the filling, compaction, plastic deformation and ejection positions by means of curved guide rails. At those places where the punches have to be raised or lowered to a particularly significant extent (filling, compaction, ejection), these curved guide rails are supported by additional push-down members, pull-down rails and ejection paths. The die is filled from a rigidly arranged feed unit, the so-called filling shoe, which is connected to a storage container for the premix. The pressure applied to the premix can be individually adjusted through the tools for the top and bottom punches, pressure being built up by the rolling of the punch shank heads past adjustable pressure rollers.

To increase throughput, rotary presses can also be equipped with two filling shoes so that only half a circle has to be negotiated to produce a tablet. To produce two-layer or multiple-layer tablets, several filling shoes are arranged one behind the other without the lightly compacted first layer being ejected before further filling. Given suitable process control, shell and bull's-eye tablets—which have a structure resembling an onion skin—can also be produced in this, way. In the case of bull's-eye tablets, the upper surface of the core or rather the core layers is not covered and thus remains visible. Rotary tablet presses can also be equipped with single or multiple punches so that, for example, an outer circle with 50 bores and an inner circle with 35 bores can be simultaneously used for tabletting. Modern rotary tablet presses have throughputs of more than one million tablets per hour.

Where rotary presses are used for tabletting, it has proved to be of advantage to carry out the tabletting process with minimal variations in the weight of the tablets. Variations in tablet hardness can also be reduced in this way. Minimal variations in weight can be achieved as follows:
using plastic inserts with minimal thickness tolerances
low rotor speed
large filling shoe
adapting the rotational speed of the filling shoe blade to the rotor speed
filling shoe with constant powder height
decoupling the filling shoe from the powder supply

Any of the nonstick coatings known in the art may be used to reduce caking on the punch. Plastic coatings, plastic inserts or plastic punches are particularly advantageous. Rotating punches have also proved to be of advantage; if possible, the upper and lower punches should be designed for rotation. If rotating punches are used, there will generally be no need for a plastic insert. In that case, the surfaces of the punch should be electropolished.

It has also been found that long tabletting times are advantageous. These can be achieved by using pressure rails, several pressure rollers or low rotor speeds. Since variations in tablet hardness are caused by variations in the pressures applied, systems which limit the tabletting pressure should be used. Elastic punches, pneumatic compensators or spring elements in the force path may be used. The pressure roller can also be spring-mounted.

Preferred processes according to the invention are characterized in that tabletting in step a) is carried out under pressures of 0.01 to 50 kNcm⁻², preferably 0.1 to 40 kNcm⁻² and more preferably 1 to 25 kNcm⁻².

Tabletting machines suitable for the purposes of the invention can be obtained, for example, from the following companies: Apparatebau Holzwarth GbR, Asperg; Wilhelm. Fette GmbH, Schwarzenbek; Hofer GmbH, Weil; Horn & Noack Pharmatechnik GmbH, Worms; IMA Verpackungssysteme GmbH Viersen; KILIAN, Cologne; KOMAGE, Kell am See, KORSCH Pressen GmbH, Berlin; and Romaco GmbH, Worms. Other suppliers are, for example Dr. Herbert Pete, Vienna (AU); Mapag Maschinenbau AG, Bern (Switzerland); BWI Manesty, Liverpool (GB); I. Holand Ltd., Nottingham (GB); and Courtoy N.V., Halle (BE/LU) and Medicopharm, Kamnik (SI). One example of a particularly suitable tabletting machine is the model HPF 630 hydraulic double-pressure press manufactured by LAEIS, D. Tabletting tools are obtainable, for example, from Adams Tablettierwerkzeuge Dresden; Wilhelm Fett GmbH, Schwarzenbek; Klaus Hammer, Solingen; Herber & Söhne GmbH, Hamburg; Hofer GmbH, Weil; Horn & Noack, Pharmatechnik GmbH, Worms; Ritter Pharmatechnik GmbH, Hamburg; Romaco GmbH, Worms and Notter Werkzeugbau, Tamm. Other suppliers are, for example, Senss AG, Reinach (CH) and Medicopharm, Kamnik (SI).

The cavity in the tablet produced in step a) may assume any shape. It may extend throughout the tablet, i.e. may have an opening at the top and bottom of the tablet, although it may also be a cavity which does not extend throughout the tablet, i.e. a cavity of which the opening is only visible on one side of the tablet.

The tablets produced in accordance with the invention may assume any geometric form, concave, convex, biconcave, biconvex, cubic, tetragonal, orthorhombic, cylindrical, spherical, cylinder-segment-like, disk-shaped, tetrahedral, dodecahedral, octahedral, conical, pyramidal, ellipsoidal, pentagonal-, heptagonal- and hexagonal-prismatic and rhombohedral forms being particularly preferred. Completely irregular bases, such as arrow and animal shapes, trees, clouds etc. can also be produced. If the tablets according to the invention have corners and edges, they are preferably rounded off. As an additional optical differentiation, an embodiment with rounded-off corners and bevelled (“chamfered”) edges is preferred.

The tablets according to the invention may of course also be produced as multiphase tablets. In the interests of process economy, two-layered tablets have proved to be particularly effective.

The shape of the cavity can also be freely selected within broad limits irrespective of the production process selected in step a). In the interests of process economy, holes which open on opposite sides of the tablets and recesses which open on one side only have proved successful. In preferred detergent tablets, the cavity is in the form of a hole opening on two opposite sides of the tablet. The shape of this hole may be freely selected, preferred tablets being characterized in that the hole has circular, ellipsoidal, triangular, rectangular, square, pentagonal, hexagonal, heptagonal or octagonal horizontal sections. The hole may also assume completely irregular shapes, such as arrow or animal shapes, trees, clouds, etc. As with the tablets, angular holes preferably have rounded-off corners and edges or rounded-off corners and chamfered edges.

The geometric forms mentioned above may be combined as required with one another. Thus, tablets with a rectangular or square base and circular holes can be produced just as well as round tablets with octagonal holes, the various combination possibilities being unlimited. In the interests of process economy and aesthetic consumer appeal, particularly preferred holed tablets are characterized in that the base of the tablet and the cross-section of the hole have the same geometric form, for example tablets with a square base and a centrally located square hole. Ring tablets, i.e. circular tablets with a circular hole, are particularly preferred.

If the above-mentioned principle of the hole open on two opposite sides of the tablet is reduced to one opening, the result is a recess tablet. Detergent tablets produced in accordance with the invention in which the cavity assumes the form of a recess are also preferred. As with the “hole tablets”, the tablets according to the invention in this embodiment, too, may assume any geometric form, concave, convex, biconcave, biconvex, cubic, tetragonal, orthorhombic, cylindrical, spherical, cylinder-segment-like, disk-shaped, tetrahedral, dodecahedral, octahedral, conical, pyramidal, ellipsoidal, pentagonal-, heptagonal- and octagonal-prismatic and rhombohedral forms being particularly preferred. The base of the tablet may even assume a completely irregular shape, such as arrow or animal shapes, trees, clouds, etc. If the tablet has corners and edges, they are preferably rounded-off. As an additional optical differentiation, an embodiment with rounded-off corners and chamfered (“bevelled”) edges is preferred.

The shape of the recess may also be freely selected, tablets in which at least one recess may assume a concave, convex, cubic, tetragonal, orthorhombic, cylindrical, spherical, cylinder-segment-like, disk-shaped, tetrahedral, dodecahedral, octahedral, conical, pyramidal, ellipsoidal, pentagonal-, heptagonal- and hexagonal-prismatic and rhombohedral form being preferred. The recess may also assume a totally irregular shape, such as arrow or animal shapes, trees, clouds etc. As with the tablets, recesses with rounded-off corners and edges or with rounded-off corners and chamfered edges are preferred. The recess shapes described in German patent application DE 198 22 973 A1 (Henkel KGaA), to which reference is expressly made here, are particularly preferred.

The size of the recess or the hole by comparison with the tablet as a whole is governed by the application envisaged for the tablets. The size of the cavity can vary according to whether it is to be filled with more active substance and whether a relatively small or relatively large quantity of active substance is intended to be present. Irrespective of the intended application, preferred detergent tablets are characterized in that the ratio by volume of tablet to cavity is 2:1 to 100:1, preferably 3:1 to 80:1, more preferably 4:1 to 50:1 and most preferably 5:1 to 30:1. The ratio by volume is calculated from the volume of the finished tablet according to the invention, i.e. the tablet with the cavity closed by the film, and the volume of the cavity. The difference between the two volumes is the volume of the cavity tablet in which the cavity is not closed by film. In other words: if the tablet has, for example, an orthorhombic shape with side lengths of 2, 3 and 4 cm and has a cavity with a volume of 2 cm³, the volume of this “basic tablet” is 22 cm³. The volume used to calculate the ratio is 24 cm³ because the cavity is closed by a film so that, to the outside, the tablet is orthorhombic with no cavity. Accordingly, in this example, the ratio between the volumes is 12:1. With tablet:cavity volume ratios below 2:1, which of course are also possible in accordance with the invention, the instability of the walls can increase.

Similar observations may also be made on the contribution which the tablet with the cavity (“basic tablet”) or the opening area of the cavity makes to the total surface area of the tablet. Here, preferred detergent tablets are characterized in that the area of the opening(s) of the cavity(ies) makes up 1 to 25%, preferably 2 to 20%, more preferably 3 to 15% and most preferably 4 to 10% of the total surface area of the tablet. The total surface area of the tablet again corresponds to the total surface area of the tablet with the closed cavity, i.e. in the above example 52 cm² irrespective of the area of the cavity opening(s). Accordingly, in an exemplary tablet such as this, the opening(s) of the cavity in preferred embodiments of the invention has/have an area of 0.52 to 13 cm², preferably 1.04 to 10.4 cm², more preferably 1.56 to 7.8 cm² and most preferably 2.08 to 5.2 cm².

In step b), the cavity is filled with active substance(s), active-substance mixtures or active-substance preparations. If the cavity has more than one opening, it is advisable for process-related reasons to close the second, third and any other openings in order in this way to simplify the filling process. Although it would also be possible in principle first to fill a ring tablet and then to close the upper opening of the hole, to turn over the tablet together with its filling and to close the second hole also, this would require mechanisms to prevent the filling from dropping out. If, therefore, the cavity of the tablet produced in step a) has more than one opening, the optional step b)—filling—is preferably carried out after step c) has been carried out (n−1) times where n is the number of openings. Accordingly, closing of the last opening corresponds to the last time process step c) is carried out to be followed by further process steps.

The tablets produced in accordance with the invention consist of a basic tablet with one or more cavities, film(s) which close(s) these cavity(ies) and active substance(s) optionally present in the cavity(ies). The film materials and preferred physical parameters of the films are described in the following. The ingredients of the basic tablet, which may also be active substances present in the cavity, will now be described and preferred physical parameters for basic tablets and cavity fillings will also be listed. By incorporating certain ingredients, it is possible on the one hand selectively to accelerate the solubility of the cavity filling; on the other hand, the release of certain ingredients from that filling can lead to advantages in the washing/dishwashing process. Ingredients which, preferably, are at least partly localized in the cavity are, for example, the surfactants, enzymes, soil-release polymers, builders, bleaching agents, bleach activators, bleach catalysts, optical brighteners, silver protectors, etc. described in the following.

In preferred embodiments of the present invention, the basic tablet has a high specific gravity. According to the invention, detergent tablets which are characterized in that the basic tablet has a density above 1000 kgdm⁻³, preferably above 1025 kgdm⁻³, more preferably above 1050 kgdm³ and most preferably above 1100 kgdm⁻³ are preferred.

Step a) of the second preferred variant of the process for producing the basic tablet by thermoforming and/or casting and/or injection molding and/or blow molding a water-soluble or water-dispersible polymer or polymer mixture is described in the following:

The production of unfilled basic tablets by molding is carried out by any of the processes typically used in the plastics industry, film production and further processing, blow molding and injection molding being particularly preferred. In all these processes, plastic granules are melted in an extruder and delivered to molds.

In a preferred embodiment of the present invention, the melt leaving the extruder is blow-molded. Blow-molding processes suitable for the purposes of the invention include extrusion blow-molding, coextrusion blow-molding, injection stretch blow-molding and dip blow-molding. In blow-molding, the wall thicknesses of the moldings can be made locally different by making the walls of the parison correspondingly different in thickness, preferably along its vertical axis, preferably by regulating the quantity of thermoplastic material, preferably by means of an adjusting spindle during the discharge of the parison from the extruder nozzle.

The powder- or liquid-filled solid body can be blow-molded with regions differing in their outer circumference but having the same wall thickness by making the walls of the parison correspondingly different in thickness, preferably along its vertical axis, preferably by regulating the quantity of thermoplastic material by means of an adjusting spindle during the discharge of the parison from the extruder nozzle.

Different geometric forms of the molding with and without compartments can be blow-molded in this way. Bottles, spheres, Father Christmases, Easter bunnies and other figures can thus be blow-molded in a single molding cycle and filled with detergent.

A particular advantage is that the molding can be embossed and/or decorated during blow molding in the blow mold. By correspondingly designing the blow mold, a motif can be transferred as a mirror image to the molding. In this way, the surface of the molding can be made to assume virtually any form. For example, information in the form of calibration marks, directions for use, danger symbols, marks, weight, contents, sell-by dates, images, etc. can thus be applied to the molding.

The pan son and/or the basic tablet may be tubular, spherical or bladder-shaped. A spherical molding has a shape factor of >0.8, preferably >0.82, more preferably >0.85, most preferably >0.9 and more particularly >0.95.

The shape factor in the context of the present invention can be precisely determined by modern particle measuring techniques with digital image processing. A typical process is, for example, the Camsizer® system (Retsch Technology) or the KeSizer® system (Kemira). In these processes, the moldings are illuminated by a light source and detected as projection areas, digitalized and processed by computer. The surface curvature is determined by an optical measuring technique in which the “shadow” cast by the molding to be analyzed is determined and converted into a corresponding shape factor. The basic principle for determination of the shape factor was described, for example, by Gordon Rittenhouse in “A visual method of estimating two-dimensional sphericity” in “Journal of Sedimentary Petrology”, Vol. 13, No. 2, pages 79-81. The measuring limits of this visual analytical method are 15 μm to 90 mm. Methods of determining the shape factor for larger particles are known to the expert and are generally based on the principles of the above-mentioned processes.

The walls of the moldings produced by blow molding have a thickness of 0.05 to 5 mm, preferably 0.06 to 2 mm, more preferably 0.07 to 1.5 mm, most preferably 0.08 to 1.2 mm or 0.09 to 1 mm and more particularly 0.1 to 0.6 mm.

After filling, the opening of the blow molding can be sealed in liquid-tight manner in step c), corresponding rims preferably being provided around the filling opening during the blow-molding step.

In another preferred embodiment of the present invention, the melt of water-soluble polymer blend leaving the extruder is molded by an injection molding process. The injection molding process is carried out in known manner at high temperatures and pressures with the steps of closing the mold connected to the injection molding extruder, injecting the polymer at high temperature and pressure, cooling the injection molding, opening the mold and removing the molded blank. Other optional steps, such as the application of release agents, demolding, etc., are known to the expert and may be carried out using known technology.

The advantages of production by injection molding lie in the proven technology of this process, in the wide freedom of choice in relation to the materials used, in the possibility of obtaining the exact wall thicknesses required for the molding or dimensionally stable basic tablet and in the possibility of producing a dimensionally stable basic tablet with one or more integral compartmenting means with high reproducibility in a single step.

In preferred processes, injection molding is carried out at a pressure of up to 5,000 bar, preferably between 2 and 2,500 bar, more preferably between 5 and 2,000 bar, most preferably between 10 and 1,500 bar and more particularly between 100 and 1,250 bar.

The temperature of the material to be injection-molded is preferably above the melting or softening point of the material and, hence, also depends on the nature and composition of the polymer blend. In preferred processes according to the invention, injection molding is carried out at temperatures in the range from 100 to 250° C., preferably at temperatures in the range from 120 to 200° C. and more particularly at temperatures in the range from 140 to 180° C.

The molds which accommodate the materials are preferably preheated and have temperatures above room temperature, temperatures of 25 to 60° C. being preferred and temperatures of 35 to 50° C. being particularly preferred.

Irrespective of the material used for the basic tablets, the wall thickness can be varied according to the required dissolving properties. On the one hand, the wall should be so thin that rapid dissolution or disintegration is achieved and the ingredients are quickly released into the wash liquor. On the other hand, a certain minimum thickness is necessary for providing the basic tablet with the required stability, above all dimensional stability.

Preferred wall thicknesses for injection moldings are in the range from 100 to 5,000 μm, preferably in the range from 200 to 3,000 μm, more preferably in the range from 300 to 2,000 μm and most preferably in the range from 500 to 1,500 μm.

The injection molding does not normally have continuous walls on all sides, i.e. is open on at least one of its sides from the production process—in the case of a spherical or elliptical molding in the region of part of its shell. One or more preparation(s) is/are introduced into the compartment(s) formed within the molding through the remaining opening. This is also done in known manner, for example using production processes known from the confectionery industry; multistage processes could also be used. A single-stage process is preferred in particular when, in addition to solid preparations, preparations containing liquid components (dispersions or emulsions, suspensions) or even preparations containing gaseous components (foams) are to be introduced into moldings.

In thermoforming, a film of suitable material is placed over a mold formed with depressions, optionally heated and then drawn into the depressions by application of reduced pressure. Alternatively or in addition, the film may be pressed into the mold by application of pressure from above or by a punch. Preferred wall thicknesses for thermoformed moldings are in the range from 100 to 5,000 μm, preferably in the range from 200 to 3,000 μm, more preferably in the range from 300 to 2,000 μm and most preferably in the range from 500 to 1,500 μm.

Irrespective of the method used to produce basic tablets of water-soluble or water-dispersible polymers, the basic tablets preferably have margings to which the labels may be applied in a following process step. The width of these margins is preferably at least 2 mm.

Suitable materials for the basic tablets of water-soluble or water-dispersible polymers are any of the polymers which may also be used for the sealing film. These polymers are described hereinafter.

As mentioned at the beginning of the specification, the basic tablet can be produced in step a) of the process according to the invention by casting of water-soluble or water-dispersible polymers or polymer mixtures or dispersions.

The production of the basic tablet in step a) may be carried out by various processes.

In the most simple case, a flowable mixture is introduced into a suitable mold. If the mixture were left to solidify in that mold, a compact body rather than a basic tablet would be obtained. By suitable process management, it can be ensured that the mixture initially solidifies on the Wall of the mold. If the mold is turned over after a certain time t, the excess mixture flows off and leaves behind a lining of the mold which itself represents a basic tablet that can be demolded after complete solidification.

Accordingly, another preferred embodiment of the present invention is a process for the production of detergent tablets in which, to produce the basic tablet,
a) a water-soluble or water-dispersible polymer or polymer mixture or a water-soluble or water-dispersible dispersion is cast into the cavity of a mold and
b) the cavity is turned over and the excess polymer or polymer mixture or excess dispersion is poured out.

Depending on the solidification mechanism, the mold is preferably turned over after a time t of 0 to 20 minutes, preferably after a time t of 1 to 17 minutes, more preferably after a time t of 2 to 14 minutes, most preferably after a time t of 3 to 11 minutes and more particularly after a time t of 4 to 8 minutes.

As an alternative to completely filling the cavity and pouring off excess material, the cavity may be only partly filled. In such cases, the water-soluble or water-dispersible polymer or polymer mixture or the water-soluble or water-dispersible dispersion is pressed by a suitable punch onto the wall of the cavity where it solidifies to form the mold. This procedure is virtually a cross between the “pouring off technique” and casting in negative molds of the basic tablets.

According to the invention, corresponding processes for the production of basic tablets comprising the steps of
a) casting a water-soluble or water-dispersible polymer or polymer mixture or a water-soluble or water-dispersible dispersion into the cavity of a mold;
b) displacing the polymer or polymer mixture or the dispersion by means of a stamp
   are particularly preferred.

A particular advantage of this process, which is also known as the cold stamp method, is the possibility of producing very large numbers of the basic tablets with exact wall thicknesses. In addition, the process is largely unaffected by varying flow properties and can even be applied to relatively high-viscosity mixtures. In a preferred embodiment of this preferred variant, a cooled stamp is used. The temperature of this cooled stamp is preferably between 5 and 20° C., more preferably between 8 and 19° C., most preferably between 11 and 18° C. and more particularly between 14 and 17° C.

The processes described above are particularly suitable for producing basic tablets with no undercuts, i.e. in the form of a “bowl”, i.e. an opening surface which corresponds to the largest horizontal cross-sectional area. These “bowls” can be filled and optionally sealed.

There are no limits to the shape of the bowls which may be produced in any shape ranging from hemispheres via angular (“box-like”) bowls to complicated structures with an embossed surface texture (for example in the form of nutshells or animal shapes).

In a preferred variant of the process according to the invention, the “noses” or edges of solidified detersive preparation hanging down from the mold can be cut off or scraped off by blades and/or removed by a roller from the basic tablets produced by turning over or displacement either during or after the solidification phase. In a particularly preferred embodiment of the process according to the invention, heated blades or scrapers or rollers are used for cutting or scarping or rolling. The temperature of these heated blades, scrapers or rollers is at least 35° C., preferably at least 45° C. and more particularly between 50 and 90° C.

However, it is also possible in accordance with the invention to produce basic tablets which have only a small opening and subsequently to fill the basic tablet formed through this small “bunghole”. On an industrial scale, corresponding processes are generally carried out using closable double molds which are filled with a quantity of solidifying mixture sufficient to line the wall in the required thickness and moved in all spatial directions. Any geometric forms are possible from spheres via egg shapes to complicated hollow structures, such as animal shapes, company logos, etc. Accordingly, another preferred embodiment of the present invention is a process for the production of detergent tablets in which the basic tablets are produced in step a) by
a) casting a water-soluble or water-dispersible polymer or polymer mixture or a water-soluble or water-dispersible dispersion into a closable double mold and
b) moving the double mold for between 0 and 20 minutes.

Irrespective of whether the basic tablets are produced by tabletting or by other processes, they are filled with active substance(s) in step b) of the process according to the invention. In cases where tablets form the basic tablets, various active substances may be present in the tablets. If the basic tablets are produced by other processes, they may again already contain active substance (for example dyes, enzymes, optical brighteners, redispersants, complexing agents, etc., i.e. so-called minor components), although most of the active substance will be present in the filling.

The preferred ingredients of the basic tablet are described in the following. All the substances mentioned may of course also form part of the filling—where the basic tablet is made from water-soluble or water-dispersible polymers, most of each of the substances mentioned hereinafter will be present in the filling. Accordingly, where they relate explicitly to the “basic tablet”, the following observations may be interpreted to mean the “basic tablet and/or filling”.

According to the present invention, preferred detergent tablets are characterized in that the basic tablet contains builders in quantities of 1 to 100% by weight, preferably in quantities of 5 to 95% by weight, more preferably in quantities of 10 to 90% by weight and most preferably in quantities of 20 to 85% by weight, based on the weight of the basic tablet.

The detergent tablets produced in accordance with the invention may contain any of the builders typically used in detergents, i.e. in particular zeolites, silicates, carbonates, organic cobuilders and—providing there are no ecological objections to their use—also the phosphates.

Suitable crystalline layered sodium silicates correspond to the general formula NaMSiₓO₂ₓ₊₁.H₂O, where M is sodium or hydrogen, x is a number of 1.9 to 4 and y is a number of 0 to 20, preferred values for x being 2, 3 or 4. Preferred crystalline layered silicates corresponding to the above formula are those in which M is sodium and x assumes the value 2 or 3. Both β- and δ-sodium disilicates Na₂Si₂O₅.yH₂O are particularly preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. However, particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. Compacted amorphous silicates, compounded amorphous silicates and overdried X-ray-amorphous silicates are particularly preferred.

Preferred detergent tablets produced in accordance with the invention are characterized in that the basic tablet contains silicate(s), preferably alkali metal silicates and, more preferably, crystalline or amorphous alkali metal disilicates in quantities of 10 to 60% by weight, preferably in quantities of 15 to 50% by weight and more preferably in quantities of 20 to 40% by weight, based on the weight of the basic tablet.

The finely crystalline, synthetic zeolite containing bound water used in accordance with the invention is preferably zeolite A and/or zeolite P. Zeolite MAP® (Crosfield) is a particularly preferred P-type zeolite. However, zeolite X and mixtures of A, X and/or P are also suitable. According to the invention, it is preferred to use, for example, a commercially obtainable co-crystallizate of zeolite X and zeolite A (ca. 80% by weight zeolite X) which is marketed by CONDEA Augusta S.p.A. under the name of VEGOBOND AX® and which may be described by the following formula:
nNa₂O.(1-n)K₂O.Al₂O₃.(2-2.5)SiO₂.(3.5-5.5)H₂O.

The zeolite may be used both as a builder in a granular compound and for “powdering” the entire mixture to be tabletted, both these options normally being used to incorporate the zeolite in the premix. Suitable zeolites have a mean particle size of less than 10 μm (volume distribution, as measured by the Coulter Counter Method) and contain preferably 18 to 22% by weight and more preferably 20 to 22% by weight of bound water.

The generally known phosphates may of course also be used as builders providing their use should not be avoided on ecological grounds. Among the large number of commercially available phosphates, alkali metal phosphates have the greatest importance in the detergent industry, pentasodium triphosphate and pentapotassium triphosphate (sodium and potassium tripolyphosphate) being particularly preferred.

“Alkali metal phosphates” is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits on machine parts and lime incrustations in fabrics and, in addition, contribute towards the cleaning effect.

Sodium dihydrogen phosphate (NaH₂PO₄) exists as the dihydrate (density 1.91 gcm⁻³, melting point 600) and as the monohydrate (density 2.04 gcm⁻³). Both salts are white readily water-soluble powders which, on heating, lose the water of crystallization and, at 200° C., are converted into the weakly acidic diphosphate (disodium hydrogen diphosphate, Na₂H₂P₂O₇) and, at higher temperatures, into sodium trimetaphosphate (Na₃P₃O₉) and Maddrell's salt (see below). NaH₂PO₄ shows an acidic reaction. It is formed by adjusting phosphoric acid with sodium hydroxide to a pH value of 4.5 and spraying the resulting “mash”. Potassium dihydrogen phosphate (primary or monobasic potassium phosphate, potassium biphosphate, KDP), KH₂PO₄, is a white salt with a density of 2.33 gcm⁻³, has a melting point of 253° [decomposition with formation of potassium polyphosphate (KPO₃)ₓ] and is readily soluble in water.

Disodium hydrogen phosphate (secondary sodium phosphate), Na₂HPO₄, is a colorless, readily water-soluble crystalline salt. It exists in water-free form and with 2 mol (density 2.066 gcm⁻³, water loss at 950), 7 mol (density 1.68 gcm⁻³, melting point 48° with loss of 5H₂O) and 12 mol water (density 1.52 gcm⁻³, melting point 35° with loss of 5H₂O), becomes water-free at 100° and, on fairly intensive heating, is converted into the diphosphate Na₄P₂O₇. Disodium hydrogen phosphate is prepared by neutralization of phosphoric acid with soda solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, consists of colorless crystals which have a density of 1.62 gcm⁻³ and a melting point of 73-76° (decomposition) as the dodecahydrate, a melting point of 1000 as the decahydrate (corresponding to 19-20% P₂O₅) and a density of 2.536 gcm⁻³ in water-free form (corresponding to 0.3940% P₂O₅). Trisodium phosphate is readily soluble in water through an alkaline reaction and is prepared by concentrating a solution of exactly 1 mol disodium phosphate and 1 mol NaOH by evaporation. Tripotassium phosphate (tertiary or tribasic potassium phosphate), K₃PO₄, is a white deliquescent granular powder with a density of 2.56 gcm⁻³, has a melting of 13400 and is readily soluble in water through an alkaline reaction. It is formed, for example, when Thomas slag is heated with coal and potassium sulfate. Despite their higher price, the more readily soluble and therefore highly effective potassium phosphates are often preferred to corresponding sodium compounds in the detergent industry.

Tetrasodium diphosphate (sodium pyrophosphate), Na₄P₂O₇, exists in water-free form (density 2.534 gcm⁻³, melting point 988°, a figure of 880° has also been mentioned) and as the decahydrate (density 1.815-1.836 gcm⁻³, melting point 94° with loss of water). Both substances are colorless crystals which dissolve in water through an alkaline reaction. Na₄P₂O₇ is formed when disodium phosphate is heated to >200° or by reacting phosphoric acid with soda in a stoichiometric ratio and spray-drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³ which is soluble in water, the pH value of a 1% solution at 25° being 10.4.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types in particular are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is a non-hygroscopic white water-soluble salt which crystallizes without water or with 6H₂O and which has the general formula NaO—[P(O)(ONa)—O]ₙ—Na where n=3. Around 17 g of the salt free from water of crystallization dissolve in 100 g of water at room temperature, around 20 g at 60° and around 32 g at 1000. After heating of the solution for 2 hours to 1000, around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray-dried. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is marketed for example in the form of a 50% by weight solution (>23% P₂O₅, 25% K₂O). The potassium polyphosphates are widely used in the detergent industry. Sodium potassium tripolyphosphates, which may also be used in accordance with the invention, also exist. They are formed for example when sodium trimetaphosphate is hydrolyzed with KOH:
(NaPO₃)₃+2KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

Preferred detergent tablets produced in accordance with the invention are characterized in that the basic tablet contains phosphate(s), preferably alkali metal phosphate(s) and more preferably pentasodium or pentapotassium triphosphate (sodium or potassium tripolyphosphate) in quantities of 20 to 80% by weight, preferably in quantities of 25 to 7%% by weight and more preferably in quantities of 30 to 70% by weight, based on the weight of the basic tablet.

Alkalinity sources may be present as further constituents. Alkalinity sources are, for example, alkali metal hydroxides, alkali metal carbonates, alkali metal hydrogen carbonates, alkali metal sesquicarbonates, the alkali metal silicates mentioned, alkali metal metasilicates and mixtures thereof. According to the present invention, preferred alkalinity sources are the alkali metal carbonates, more particularly sodium carbonate, sodium hydrogen carbonate and sodium sesquicarbonate. A builder system containing a mixture of tripolyphosphate and sodium carbonate is particularly preferred, as is a builder system containing a mixture of tripolyphosphate and sodium carbonate and sodium disilicate.

In particularly preferred detergent tablets produced in accordance with the invention, the basic tablet contains carbonate(s) and/or hydrogen carbonate(s), preferably alkali metal carbonates and more preferably sodium carbonate, in quantities of 5 to 50% by weight, preferably in quantities of 7.5 to 40% by weight and more preferably in quantities of 10 to 30% by weight, based on the weight of the basic tablet.

Organic cobuilders suitable for use in the detergent tablets according to the invention are, in particular, polycarboxylates/polycarboxylic acids, polymeric polycarboxylates, aspartic acid, polyacetals, dextrins, other organic cobuilders (see below) and phosphonates. These classes of substances are described in the following.

Useful organic builders are, for example, the polycarboxylic acids usable, for example, in the form of their sodium salts, polycarboxylic acids in this context being understood to be carboxylic acids which bear more than one acid function. Examples of such carboxylic acids are citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their builder effect, the acids also typically have the property of an acidifying component and, hence, also serve to establish a relatively low and mild pH value in detergents. Citric acid, succinic acid, glutaric acid, adipic acid, gluconic acid and mixtures thereof are particularly mentioned in this regard.

Other suitable builders are polymeric polycarboxylates such as, for example, the alkali metal salts of polyacrylic or polymethacrylic acid, for example those with a relative molecular weight of 500 to 70,000 g/mol.

The molecular weights mentioned in this specification for polymeric polycarboxylates are weight-average molecular weights M_{w} of the particular acid form which, basically, were determined by gel permeation chromatography (GPC) using a UV detector. The measurement was carried out against an external polyacrylic acid standard which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates which preferably have a molecular weight of 2,000 to 20,000 g/mol. By virtue of their superior solubility, preferred representatives of this group are the short-chain polyacrylates which have molecular weights of 2,000 to 10,000 g/mole and, more particularly, 3,000 to 5,000 g/mol.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2,000 to 70,000 g/mol, preferably in the range from 20,000 to 50,000 g/mol and more preferably in the range from 30,000 to 40,000 g/mol.

The (co)polymeric polycarboxylates may be used either in powder form or in the form of an aqueous solution. The content of (co)polymeric polycarboxylates in the detergent is preferably from 0.5 to 20% by weight and more preferably from 3 to 10% by weight.

In order to improve solubility in water, the polymers may also contain allyl sulfonic acids such as, for example, allyloxybenzene sulfonic acid and methallyl sulfonic acid, as monomer.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylallyl sulfonic acid and sugar derivatives as monomers.

Other preferred copolymers are those which preferably contain acrolein and acrylic acid/acrylic acid salts or acrolein and vinyl acetate as monomers.

Other preferred builders are polymeric aminodicarboxylic acids, salts or precursors thereof. Particular preference is attributed to polyaspartic acids or salts and derivatives thereof which have a bleach-stabilizing effect in addition to their co-builder properties.

Other suitable builders are polyacetals which may be obtained by reaction of dialdehydes with polyol carboxylic acids containing 5 to 7 carbon atoms and at least 3 hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable organic builders are dextrins, for example oligomers or polymers of carbohydrates which may be obtained by partial hydrolysis of starches. The hydrolysis may be carried out by standard methods, for example acid- or enzyme-catalyzed methods. The end products are preferably hydrolysis products with average molecular weights of 400 to 500,000 g/mol. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose sirups with a DE of 20 to 37 and also so-called yellow dextrins and white dextrins with relatively high molecular weights of 2,000 to 30,000 g/mol may be used.

The oxidized derivatives of such dextrins are their reaction products with oxidizing agents which are capable of oxidizing at least one alcohol function of the saccharide ring to the carboxylic acid function. A product oxidized at C₆ of the saccharide ring can be particularly advantageous.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups.

Another class of substances with co-builder properties are the phosphonates, more particularly hydroxyalkane and aminoalkane phosphonates. Among the hydroxyalkane phosphonates, 1-hydroxyethane-1,1-diphosphonate (HEDP) is particularly important as a co-builder. It is preferably used in the form of the sodium salt, the disodium salt showing a neutral reaction and the tetrasodium salt an alkaline reaction (pH 9). Preferred aminoalkane phosphonates are ethylenediamine tetramethylene phosphonate (EDTMP), diethylenetriamine pentamethylenephosphonate (DTPMP) and higher homologs thereof. They are preferably used in the form of the neutrally reacting sodium salts, for example as the hexasodium salt of EDTMP or as the hepta- and octasodium salts of DTPMP. Of the phosphonates, HEDP is preferably used as a builder. In addition, the aminoalkane phosphonates have a pronounced heavy metal binding capacity. Accordingly, it can be of advantage, particularly where the detergents also contain bleach, to use aminoalkane phosphonates, more particularly DTPMP, or mixtures of the phosphonates mentioned.

In addition, any compounds capable of forming complexes with alkaline earth metal ions may be used as co-builders.

The quantity of builder used is normally between 10 and 70% by weight, preferably between 15 and 60% by weight and more preferably between 20 and 50% by weight, based on the basic tablet. The quantity of builder used is again dependent upon the particular application envisaged, so that bleach tablets can contain larger quantities of builders (for example between 26 and 70% by weight, preferably between 25 and 65% by weight and more preferably between 30 and 55% by weight) than, for example, laundry detergent tablets (normally 10 to 50% by weight, preferably 12.5 to 45% by weight and more preferably 17.5 to 37.5% by weight).

The above-mentioned substances from the group of builders and co-builders may of course be part of the compositions present in the cavity.

Preferred detergent tablets produced in accordance with the invention additionally contain one or more surfactant(s). Anionic, nonionic, cationic and/or amphoteric surfactants or mixtures thereof may be used in the detergent tablets according to the invention. From the performance perspective, mixtures of anionic and nonionic surfactants are preferred for laundry detergent tablets while nonionic surfactants are preferred for dishwasher tablets. The total surfactant content of laundry detergent tablets is between 5 and 60% by weight and preferably above 15% by weight, based on tablet weight, whereas dishwasher detergent tablets preferably contain less than 5% by weight of surfactant(s).

The anionic surfactants used are, for example, those of the sulfonate and sulfate type. Preferred surfactants of the sulfonate type are C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut, palm kernel or tallow acids, are also suitable.

Other suitable anionic surfactants are sulfonated fatty acid glycerol esters, i.e. the monoesters, diesters and triesters and mixtures thereof which are obtained where production is carried out by esterification of a monoglycerol with 1 to 3 mol fatty acid or in the transesterification of triglycerides with 0.3 to 2 mol glycerol. Preferred sulfonated fatty acid glycerol esters are the sulfonation products of saturated C₆₋₂₂ fatty acids, for example caproic acid, caprylic acid, capric acid, myristic acid, lauric acid, palmitic acid, stearic acid or behenic acid.

Preferred alk(en)yl sulfates are the alkali metal salts and, in particular, the sodium salts of the sulfuric acid semiesters of C₁₂₋₁₈ fatty alcohols, for example coconut alcohol, tallow alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical and which are similar in their degradation behavior to the corresponding compounds based on oleochemical raw materials. C₁₂₋₁₆ alkyl sulfates and C₁₂₋₁₅ alkyl sulfates and also C₁₄₋₁₅ alkyl sulfates are particularly preferred from the washing performance point of view. Other suitable anionic surfactants are 2,3-alkyl sulfates which may be produced, for example, in accordance with U.S. Pat. No. 3,234,258 or U.S. Pat. No. 5,075,041 and which are commercially obtainable as products of the Shell Oil Company under the name of DAN®.

The sulfuric acid monoesters of linear or branched C₇₋₂₁ alcohols ethoxylated with 1 to 6 mol ethylene oxide, such as 2-methyl-branched C₉₋₁₁ alcohols containing on average 3.5 mol ethylene oxide (EO) or C₁₂₋₁₈ fatty alcohols containing 1 to 4 EO, are also suitable. In view of their high foaming capacity, they are normally used in only relatively small quantities, for example in quantities of 1 to 5% by weight, in cleaning compositions.

Other suitable anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol molecules or mixtures thereof. Particularly preferred sulfosuccinates contain a fatty alcohol molecule derived from ethoxylated fatty alcohols which, considered in isolation, represent nonionic surfactants (for a description, see below). Of these sulfosuccinates, those of which the fatty alcohol molecules are derived from narrow-range ethoxylated fatty alcohols are particularly preferred. Alk(en)yl succinic acid preferably containing 8 to 18 carbon atoms in the alk(en)yl chain or salts thereof may also be used.

Other suitable anionic surfactants are, in particular, soaps. Suitable soaps are, in particular, saturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil or tallow fatty acids.

The anionic surfactants, including the soaps, may be present in the form of their sodium, potassium or ammonium salts and as soluble salts of organic bases, such as mono-, di- or triethanolamine. The anionic surfactants are preferably present in the form of their sodium or potassium salts and, more preferably, in the form of their sodium salts.

Preferred nonionic surfactants are alkoxylated, advantageously ethoxylated, more especially primary alcohols preferably containing 8 to 18 carbon atoms and, on average, 1 to 12 mol ethylene oxide (EO) per mol alcohol, in which the alcohol group may be linear or, preferably, methyl-branched in the 2-position or may contain linear and methyl-branched groups in the form of the mixtures typically present in oxoalcohol groups. However, alcohol ethoxylates containing linear groups of alcohols of native origin with 12 to 18 carbon atoms, for example coconut, palm, tallow or oleyl alcohol, and on average 2 to 8 EO per mol alcohol are particularly preferred. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 5 EO. The degrees of ethoxylation mentioned represent statistical mean values which, for a special product, can be a whole number or a broken number. Preferred alcohol ethoxylates have a narrow homolog distribution (narrow range ethoxylates, NRE). In addition to these nonionic surfactants, fatty alcohols containing more than 12 EO may also be used, examples including tallow fatty alcohol containing 14 EO, 25 EO, 30 EO or 40 EO.

Suitable other nonionic surfactants are alkyl glycosides with the general formula RO(G)ₓ where R is a primary, linear or methyl-branched, more particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which indicates the distribution of monoglycosides and oligoglycosides, is a number of 1 to 10 and preferably 1.2 to 1.4.

Another class of preferred nonionic surfactants which may be used either as sole nonionic surfactant or in combination with other nonionic surfactants are alkoxylated, preferably ethoxylated or ethoxylated and propoxylated, fatty acid alkyl esters preferably containing 1 to 4 carbon atoms in the alkyl chain, more especially the fatty acid methyl esters which are described, for example, in Japanese patent application JP 58/217598 or which are preferably produced by the process described in International patent application WO-A-90/13533.

Nonionic surfactants of the amine oxide type, for example N-coconutalkyl-N,N-dimethylamine oxide and N-tallowalkyl-N,N-dihydroxyethylamine oxide, and the fatty acid alkanolamide type are also suitable. The quantity in which these nonionic surfactants are used is preferably no more than the quantity in which the ethoxylated fatty alcohols are used and, more preferably, no more than half that quantity.

Other suitable surfactants are polyhydroxyfatty acid amides corresponding to formula (I): 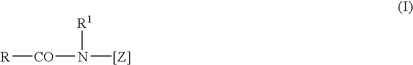
in which RCO is an aliphatic acyl group containing 6 to 22 carbon atoms, R¹ is hydrogen, an alkyl or hydroxyalkyl group containing 1 to 4 carbon atoms and [Z] is a linear or branched polyhydroxyalkyl group containing 3 to 10 carbon atoms and 3 to 10 hydroxyl groups. The polyhydroxyfatty acid amides are known substances which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to formula (II): 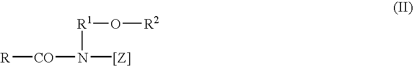
in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of that group.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95/07331.

According to the invention, detergent tablets containing anionic and nonionic surfactant(s) are preferably produced. Performance-related advantages can arise out of certain quantity ratios in which the individual classes of surfactants are used.

For example, particularly preferred detergent tablets produced in accordance with the invention are characterized in that the ratio of anionic surfactant(s) to nonionic surfactant(s) is from 10:1 to 1:10, preferably from 7.5:1 to 1:5 and more preferably from 5:1 to 1:2. Other preferred detergent tablets contain surfactant(s), preferably anionic and/or nonionic surfactant(s), in quantities of 5 to 40% by weight, preferably 7.5 to 35% by weight, more preferably 10 to 30% by weight and most preferably 12.5 to 25% by weight, based on the weight of the tablet:

It can be of advantage from the performance point of view if certain classes of surfactants are missing from certain phases of the detergent tablets or from the entire tablet, i.e. from every phase. In another important embodiment of the present invention, therefore, at least one phase of the tablets is free from nonionic surfactants.

Conversely, a positive effect can also be obtained through the presence of certain surfactants in individual phases or in the tablet as a whole, i.e. in every phase. Introducing the alkyl polyglycosides described above has proved to be of particular advantage, so that detergent tablets in which at least one phase of the tablet contains alkyl polyglycosides are preferred.

As with the nonionic surfactants, the omission of anionic surfactants from individual phases or from all phases can result in detergent tablets which are more suitable for certain applications. Accordingly, detergent tablets where at least one phase of the tablet is free from anionic surfactants are also possible in accordance with the present invention.

As already mentioned, the use of surfactants in dishwasher tablets is preferably confined to the use of nonionic surfactants in small quantities. Detergent tablets preferably produced as dishwasher tablets in accordance with the invention are characterized in that the basic tablet has total surfactant contents below 5% by weight, preferably below 4% by weight, more preferably below 3% by weight and most preferably below 2% by weight, based on the weight of the basic tablet. Normally, the only surfactants used in dishwasher detergents are low-foaming nonionic surfactants. Representatives from the groups of anionic, cationic or amphoteric surfactants are of lesser importance. In one particularly preferred embodiment, the dishwasher detergent tablets according to the invention contain nonionic surfactants, more particularly nonionic surfactants from the group of alkoxylated alcohols. Preferred nonionic surfactants are alkoxylated, advantageously ethoxylated, more especially primary alcohols preferably containing 8 to 18 carbon atoms and, on average, 1 to 12 mol ethylene oxide (EO) per mol alcohol, in which the alcohol radical may be linear or, preferably, methyl-branched in the 2-position or may contain linear and methyl-branched radicals in the form of the mixtures typically present in oxoalcohol radicals. However, alcohol ethoxylates containing linear radicals of alcohols of native origin with 12 to 18 carbon atoms, for example coconut oil, palm oil, tallow or oleyl alcohol, and on average 2 to 8 EO per mol alcohol are particularly preferred. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 5 EO. The degrees of ethoxylation mentioned represent statistical mean values which, for a special product, can be a whole number or a broken number. Preferred alcohol ethoxylates have a narrow homolog distribution (narrow range ethoxylates, NRE). In addition to these nonionic surfactants, fatty alcohols containing more than 12 EO may also be used, examples including tallow fatty alcohol containing 14 EO, 25 EO, 30 EO or 40 EO.

In a particularly preferred embodiment of the production of laundry or dishwasher detergent tablets in accordance with the invention, the laundry/dishwasher detergent tablets contain a nonionic surfactant which has a melting point above room temperature. Accordingly, at least one of the tablettable compositions used in the process according to the invention preferably contains a nonionic surfactant with a melting point above 20° C. Preferred nonionic surfactants have melting points above 25° C. while particularly preferred nonionic surfactants have melting points between 25 and 60° C. and, more particularly, between 26.6 and 43.3° C.

Suitable nonionic surfactants with melting or softening points in the temperature range mentioned above are, for example, low-foaming nonionic surfactants which may be solid or highly viscous at room temperature. If nonionic surfactants highly viscous at room temperature are used, they preferably have a viscosity above 20 Pas, more preferably above 35 Pas and most preferably above 40 Pas. Nonionic surfactants which are wax-like in consistency at room temperature are also preferred.

Nonionic surfactants solid at room temperature preferably used in accordance with the invention belong the groups of alkoxylated nonionic surfactants, more particularly ethoxylated primary alcohols, and mixtures of these surfactants with structurally complex surfactants, such as polyoxypropylene/polyoxyethylene/polyoxypropylene (PO/EO/PO) surfactants. In addition, (PO/EO/PO) nonionic surfactants are distinguished by good foam control.

In one preferred embodiment of the present invention, the nonionic surfactant with a melting point above room temperature is an ethoxylated nonionic surfactant emanating from the reaction of a monohydroxyalkanol or alkylphenol containing 6 to 20 carbon atoms with preferably at least 12 mol, more preferably at least 15 mol and most preferably at least 20 mol ethylene oxide per mol alcohol or alkylphenol.

A particularly preferred nonionic surfactant solid at room temperature is obtained from a straight-chain fatty alcohol containing 16 to 20 carbon atoms (C₁₆₋₂₀ alcohol), preferably a C₁₋₈ alcohol, and at least 12 mol, preferably at least 15 mol and more preferably at least 20 mol ethylene oxide. Of these nonionic surfactants, the so-called narrow range ethoxylates (see above) are particularly preferred.

The nonionic surfactant solid at room temperature preferably also contains propylene oxide units in the molecule. These PO units preferably make up as much as 25% by weight, more preferably as much as 20% by weight and, most preferably, up to 1.5% by weight of the total molecular weight of the nonionic surfactant. Particularly preferred nonionic surfactants are ethoxylated monohydroxyalkanols or alkylphenols which additionally contain polyoxyethylene/polyoxypropylene block copolymer units. The alcohol or alkylphenol component of these nonionic surfactant molecules preferably makes up more than 30% by weight, more preferably more than 50% by weight and most preferably more than 70% by weight of the total molecular weight of these nonionic surfactants.

Other particularly preferred nonionic surfactants with melting points above room temperature contain 40 to 70% of a polyoxypropylene/polyoxyethylene/polyoxypropylene block polymer blend which contains 75% by weight of an inverted block copolymer of polyoxyethylene and polyoxypropylene with 17 mol ethylene oxide and 44 mol propylene oxide and 25% by weight of a block copolymer of polyoxyethylene and polyoxypropylene initiated with trimethylol propane and containing 24 mol ethylene oxide and 99 mol propylene oxide per mol trimethylol propane.

Nonionic surfactants which may be used with particular advantage are obtainable, for example, under the name of Poly Tergent® SLF-18 from Olin Chemicals.

Another preferred surfactant may be described by the following formula:
R¹O[CH₂CH(CH₃)O]ₓ[CH₂CH₂O]_{y}[CH₂CH(OH)R²]
in which R¹ is a linear or branched aliphatic hydrocarbon radical containing 4 to 18 carbon atoms or mixtures thereof, R² is a linear or branched hydrocarbon radical containing 2 to 26 carbon atoms or mixtures thereof, x has a value of 0.5 to 1.5 and y has a value of at least 15.

Other preferred nonionic surfactants are the end-capped poly(oxyalkylated) nonionic surfactants corresponding to the following formula:
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals containing 1 to 30 carbon atoms, R³ stands for H or for a methyl, ethyl, n-propyl, isopropyl, n-butyl, 2-butyl or 2-methyl-2-butyl radical, x has a value of 1 to 30, k and j have values of 1 to 12 and preferably 1 to 5. Where x has a value of >2, each substituent R³ in the above formula may be different. R¹ and R² are preferably linear or branched, saturated or unsaturated, aliphatic or aromatic hydrocarbon radicals containing 6 to 22 carbon atoms, radicals containing 8 to 18 carbon atoms being particularly preferred. For the substituent R³, H, —CH₃ or ΣCH₂CH₃ are particularly preferred. Particularly preferred values for x are in the range from 1 to 20 and more particularly in the range from 6 to 15.

As mentioned above, each substituent R³ in the above formula may be different where x is ≧2. In this way, the alkylene oxide unit in the square brackets can be varied. If, for example, x has a value of 3, the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to:
R¹O[CH₂CH(R³)O]ₓCH₂CH(OH)CH₂OR²

In this formula, R¹, R² and R³ are as defined above and x has a value of 1 to 30, preferably 1 to 20 and more preferably 6 to 18. Surfactants in which the substituents R¹ and R² have 9 to 14 carbon atoms, R³ stands for H and x has a value of 6 to 15 are particularly preferred.

In order to facilitate the disintegration of heavily compacted tablets, disintegration aids, so-called tablet disintegrators, may be incorporated in the basic tablets to shorten their disintegration times. According to Römpp (9th Edition, Vol. 6, page 4440) and Voigt “Lehrbuch der pharmazeutischen Technologie” (6th Edition, 1987, pages 182-184), tablet disintegrators or disintegration accelerators are auxiliaries which promote the rapid disintegration of tablets in water or gastric juices and the release of the pharmaceuticals in an absorbable form.

These substances, which are also known as “disintegrators” by virtue of their effect, are capable of undergoing an increase in volume on contact with water so that, on the one hand, their own volume is increased (swelling) and, on the other hand, a pressure can be generated through the release of gases which causes the tablet to disintegrate into relatively small particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

Preferred detergent tablets contain 0.5 to 10% by weight, preferably 3 to 7% by weight and more preferably 4 to 6% by weight of one or more disintegration aids, based on the weight of the tablet. If only the basic tablet contains disintegration aids, the figures mentioned are based solely on the weight of the basic tablet.

According to the invention, preferred disintegrators are cellulose-based disintegrators, so that preferred detergent tablets contain a cellulose-based disintegrator in quantities of 0.5 to 10% by weight, preferably 3 to 7% by weight and more preferably 4 to 6% by weight. Pure cellulose has the formal empirical composition (C₆H₁₀O₅)ₙ and, formally, is a β-1,4-polyacetal of cellobiose which, in turn, is made up of two molecules of glucose. Suitable celluloses consist of ca. 500 to 5000 glucose units and, accordingly, have average molecular weights of 50,000 to 500,000. According to the invention, cellulose derivatives obtainable from cellulose by polymer-analog reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. In one particularly preferred embodiment, pure cellulose free from cellulose derivatives is used as the cellulose-based disintegrator.

Suitable swellable disintegration aids include, for example, bentonite and other swellable silicates. Synthetic polymers, more particularly the superabsorbers used in the hygiene sector or crosslinked polyvinyl pyrrolidone, may also be used.

Polymers based on starch and/or cellulose are used with particular advantage as swellable disintegration aids. These basic materials may be processed either on their own or as mixtures with other natural and/or synthetic polymers to form swellable disintegration aids.

In the most simple case, a cellulose-containing material or pure cellulose may be converted by granulation, compacting or other application of pressure into secondary particles which swell on contact with water and thus act as disintegrators. Mechanical wood pulp obtainable by thermal or chemo-thermal processes from wood or wood chips (sawdust, sawmill waste) has been successfully used as the cellulose-containing material. This cellulose material from the TMP (thermomechanical pulp) process or the CTMP (chemo-thermo mechanical pulp) process may then be compacted by application of pressure, preferably roller-compacted, and converted into particle form. Pure cellulose may of course also be used in exactly the same way, although it is more expensive as a raw material. Both microcrystalline and amorphous fine-particle cellulose and mixtures thereof may be used.

Another method is to granulate the cellulose-containing material in the presence of added granulation aids. For example, solutions of synthetic polymers or nonionic surfactants have proved to be effective granulation aids.

In order to avoid residues on fabrics washed with the detergents produced in accordance with the invention, the primary fiber length of the cellulose used or of the cellulose in the cellulose-containing material should be below 200 μm, primary fiber lengths below 100 μm, more particularly below 50 μm, being preferred. Ideally, the secondary particles have a particle size distribution where more than 90% by weight of the particles have sizes above 200 μm. A certain dust content can contribute towards improved storage stability of the tablets produced. Percentage fine dust (<0.1 mm) contents of up to 10% by weight and preferably of up to 8% by weight may be present in the disintegrator granules used in accordance with the invention.

The fine-particle cellulose preferably has bulk densities of 40 g/l to 300 g/l and, in a most particularly preferred embodiment, in the range from 65 g/l to 170 g/l. If already granulated types are used, their bulk density is higher and, in one advantageous embodiment, may be in the range from 350 g/l to 550 g/l. The bulk densities of the cellulose derivatives are typically in the range from 50 g/l to 1,000 g/l and preferably in the range from 100 g/l to 800 g/l.

As already mentioned, cellulose-based disintegrators which, besides cellulose, contain other active components or auxiliaries may also be used. Suitable disintegrators of this type are, for example, compacted disintegrator granules of 60 to 99% by weight of cellulose insoluble but swellable in water and optionally other modified water-swellable polysaccharide derivatives, 1 to 40% by weight of at least one polymeric binder in the form of a polymer or copolymer of (meth)acrylic acid and/or salts thereof and 0 to 7% by weight of at least one liquid surfactant gellable with water. These disintegrators preferably have a moisture content of 2 to 8% by weight.

The percentage cellulose content in such disintegrator granules is between 60 and 99% by weight and preferably between 60 and 95% by weight. Regenerated celluloses, such as viscose, may also be used in these disintegrators. Powder-form regenerated celluloses in particular are distinguished by very good water absorption. The viscose powder may be produced from chopped viscose fibers or by precipitation of dissolved viscose. Low molecular weight cellulose degraded by electron beams, for example, is also suitable for the production of such disintegrator granules.

In addition, the swellable disintegration aids present in accordance with the invention in the detergent tablets may contain water-swellable cellulose derivatives, such as cellulose ethers and cellulose esters and starch or starch derivatives and other swellable polysaccharides and polygalactomannans, for example ionically modified celluloses and starches, such as carboxymethyl-modified cellulose and starch, nonionically modified celluloses and starches, such as alkoxylated celluloses and starches, such as for example hydroxypropyl and hydroxyethyl starch or hydroxypropyl and hydroxyethyl cellulose and alkyl-etherified products, such as methyl cellulose for example, and mixed-modified celluloses and starches of the above-mentioned modifications, optionally combined with a modification that leads to crosslinking. Other suitable starches are cold-swelling starches formed by mechanical or degrading reactions on the starch grains. These include, above all, pre-gelatinized starches from extruder and drum dryer processes and products modified by enzymes, oxidation or acid degradation. Chemically derivatized starches preferably contain substituents attached to the polysaccharide chains by ester and ether groups in sufficient numbers.

Starches modified with ionic substituents, such as carboxylate, hydroxyalkyl or phosphate groups for example, have proved to be particularly advantageous and are therefore preferred. The use of lightly precrosslinked starched has also proved to be effective for improving swelling behavior. Starches treated with alkalis may also be used by virtue of their high swellability in cold water. In one advantageous embodiment, cellulose is used in combination with cellulose derivatives and/or starch and/or starch derivatives. The quantity ratios may vary within wide limits. Based on the combination, the percentage content of cellulose derivatives and/or starch and/or starch derivatives is preferably between 0.1 and 85% by weight and more particularly between 5 and 50% by weight.

Polymers or copolymers of (meth)acrylic acid or mixtures of such polymers or copolymers are used as binders in preferred disintegrator granules. The polymers are selected from the group of homopolymers of (meth)acrylic acid, from the group of copolymers with the following monomer components: ethylenically unsaturated dicarboxylic acids and/or anhydrides thereof and/or ethylenically unsaturated sulfonic acids and/or acrylates and/or vinyl esters and/or vinyl ethers or saponification products thereof and/or crosslinking agents and/or graft bases based on polyhydroxy compounds.

Uncrosslinked polymers or copolymers of (meth)acrylic acid with weight-average molecular weights of 5,000 to 70,000 have proved to be particularly suitable. The copolymers are preferably copolymers of (meth)acrylic acid and ethylenically unsaturated dicarboxylic acids or anhydrides thereof, such as maleic acid or maleic anhydride for example, which contain for example 40 to 90% by weight of (meth)acrylic acid and 60 to 10% by weight of maleic acid or maleic anhydride and of which the relative molecular weight—based on free acids—is between 3,000 and 100,000, preferably between 3,000 and 70,000 and more particularly in the range from 5,000 to 50,000. Other particularly suitable binders are terpolymeric and quattropolymeric polycarboxylates produced from (meth)acrylic acid, maleic acid and optionally fully or partly saponified vinyl alcohol derivatives or from (meth)acrylic acid, ethylenically unsaturated sulfonic acids and polyhydroxy units, such as sugar derivatives for example, or from (meth)acrylic acid, maleic acid, vinyl alcohol derivatives and monomers containing sulfonic acid groups.

The polymeric binders are preferably used in the form of aqueous solutions in the production process, but may also be used in the form of fine-particle powders. The binder polymers are preferably present in partly or fully neutralized form, salt formation preferably being carried out with cations of alkali metals, ammonia and amines or mixtures thereof.

The percentage content of polymers/copolymers in preferred disintegrators is between 1 and 40% by weight, preferably between 1 and 20% by weight and more particularly between 5 and 15% by weight. Polymer contents above 15% in the disintegrator lead to harder disintegrator granules while polymer contents below 1% tend to form soft granules that are less resistant to abrasion.

Other suitable polymer binders are crosslinked polymers of (meth)acrylic acid. They are preferably used in the form of fine-particle powders, preferably with mean particle sizes of 0.045 mm to 0.150 mm, and in quantities of preferably 0.1 to 10% by weight. Although particles with mean particle sizes above 0.150 mm also give good disintegrator granules, they do lead after dissolution of the tablets made with the granules to swollen spots visible as particles which, in the washing of fabrics for example, are visibly deposited on the fabrics to the detriment of their appearance. A combination of soluble poly(meth)acrylate homo- and copolymers and the fine crosslinked polymer particles mentioned above represents a particular embodiment of the present invention.

Preferred disintegrator granules preferably contain as additional constituents one or more liquid surfactants gellable with water selected from the group of nonionic, anionic or amphoteric surfactants which may be present in quantities of up to 7% by weight and preferably in quantities of up to 3.5% by weight. If the surfactant content in the disintegrator granules is too high, the tablets produced have poor swelling properties in addition to increased abrasion.

The nonionic surfactants were described in detail in the foregoing.

Disintegration aids preferably used in accordance with the invention are distinguished by particular swelling kinetics; their expansion as a function of time does not change linearly, but reaches a very high level after only a short time. Their swelling behavior in the first 10 seconds after contact with water is of particular interest. The specific water absorption capacity of preferred disintegration aids can be gravimetrically determined and is preferably between 500 and 2,000%.

The liquid uptake (also known as specific porosity) of preferred disintegrators is above 600 ml/kg, preferably above 750 ml/kg and more particularly in the range from 800 to 1,000 ml/kg.

Disintegrator granules are produced by first mixing the constituents of the granules by known mixing processes, for example using mixers of the type manufactured by Vomm, Lödige, Schugi, Eirich, Henschel or Fukae. So-called pre-compounds are produced by agglomeration processes in this first mixing and granulation step.

In the next step, the pre-compounds are mechanically compacted. Compaction by application of pressure can be carried out in various ways. The products can be compacted between two compression surfaces in roller compactors, for example smooth or profiled. The compactate emerges in the form of a strand. Compaction methods using female molds with punches or cushion rollers give compactates in the form of tablets or briquettes. Roller compactors, extruders, roller or cube presses and granulation presses may be used as compacting machines.

Compaction with pelleting presses has proved to be particularly suitable and, with suitable process management, gives granules that can be dried without further size reduction. Suitable pelleting presses are manufactured, for example, by the Amandus Kahl and Fitzpatrick companies.

The coarse compacted particles are size-reduced, for example in mills, shredders or roller mills. Size reduction may be carried out before or after drying. Water contents of 2 to 8% by weight, preferably 2.5 to 7% by weight and more particularly 3 to 5% by weight can be established in the drying step. Conventional dryers, such as drum dryers (temperatures between 95 and 120° C. for example) or fluidized bed dryers (temperatures of 70 to 100° C. for example), are suitable for this purpose.

Other suitable swellable disintegration aids are “co-processates” obtained from polysaccharide material and insoluble disintegrators. Particularly suitable polysaccharide materials are the above-mentioned substances from the groups of powder-form cellulose, microcrystalline cellulose and mixtures thereof. The insoluble disintegrators may be selected in particular from insoluble polyacrylic acid monopolymer, insoluble polyacrylamide monopoplymer, insoluble polyacrylic acid/polyacrylamide copolymer and mixtures thereof.

The content of the individual components in these disintegrators may vary within wide limits, for example from 1 to 60% by weight of insoluble polyacrylic product disintegrator and 40 to 99% by weight of cellulose. A content of 3 to 60% by weight of insoluble polyacrylic product disintegrator and 40 to 97% by weight of cellulose is preferred. A content of 5 to 30% by weight of insoluble polyacrylic product disintegrator and 70 to 95% by weight of cellulose is even more preferred. Small quantities of other disintegration aids, for example various starches, effervescent mixtures, for example of sodium carbonate and sodium hydrogen sulfate, etc., may optionally be added to this disintegrator, these quantities being compensated by corresponding reductions in the quantity of cellulose.

These suitable disintegrators can be obtained by co-processing a cellulose as defined above with an insoluble disintegrator as defined above by wet or dry compaction under pressure. “Co-processing” in the present context is understood to be a dry compaction process, for example between contra-rotating, compacting rollers under pressures of 20 to 60 kN and preferably 30 to 50 kN, or a wet compaction process after addition of water by kneading or pressing moist, plastic pastes through a sieve, a perforated disk or via an extruder and final drying.

The detergent tablets produced in accordance with the invention may additionally contain a gas-evolving effervescent system both in the basic tablet and in the cavity. The gas-evolving effervescent system may consist of a single substance which releases a gas on contact with water. Among these compounds, particular mention is made of magnesium peroxide which releases oxygen on contact with water. However, the gas-releasing effervescent system normally consists of at least two constituents which react with one another to form a gas. Although various possible systems could be used, for example systems releasing nitrogen, oxygen or hydrogen, the effervescent system used in the detergent tablets according to the invention should be selected with both economic and ecological considerations in mind. Preferred effervescent systems consist of alkali metal carbonate and/or hydrogen carbonate and an acidifying agent which is capable of releasing carbon dioxide from the alkali metal salts in aqueous solution.

Among the alkali metal carbonates and hydrogen carbonates, the sodium and potassium salts are preferred to the other salts for reasons of cost. The pure alkali metal carbonates and hydrogen carbonates do not of course have to be used, instead mixtures of different carbonates and hydrogen carbonates may be preferred.

In preferred detergent tablets, 2 to 20% by weight, preferably 3 to 15% by weight and more preferably 5 to 10% by weight of an alkali metal carbonate or hydrogen carbonate and 1 to 15% by weight, preferably 2 to 12% by weight and more preferably 3 to 10% by weight of an acidifying agent, based on the tablet as a whole, are used as the effervescent system.

Suitable acidifying agents which release carbon dioxide from the alkali metal salts in aqueous solution are, for example, boric acid and alkali metal hydrogen sulfates, alkali metal dihydrogen phosphates and other inorganic salts. However, organic acidifying agents are preferably used, citric acid being a particularly preferred acidifying agent. However, other solid mono-, oligo- and polycarboxylic acids in particular may also be used. Within this group, tartaric acid, succinic acid, malonic acid, adipic acid, maleic acid, fumaric acid, oxalic acid and polyacrylic acid are preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially obtainable and may also be used with advantage as an acidifying agent for the purposes of the present invention.

According to the invention, preferred detergent tablets are those in which a substance selected from the group of organic di-, tri- and oligocarboxylic acids or mixtures thereof is present as the acidifying agent in the effervescent system.

Among the compounds yielding H₂O₂ in water which serve as bleaching agents, sodium perborate tetrahydrate and sodium perborate monohydrate are particularly important. Other useful bleaching agents are, for example, sodium percarbonate, peroxypyrophosphates, citrate perhydrates and H₂O₂-yielding peracidic salts or peracids, such as perbenzoates, peroxophthalates, diperazelaic acid, phthaloiminoperacid or diperdodecane dioic acid. Dishwasher detergents according to the invention may also contain bleaching agents from the group of organic bleaches. Typical organic bleaching agents are diacyl peroxides, such as dibenzoyl peroxide for example. Other typical organic bleaching agents are the peroxy acids, of which alkyl peroxy acids and aryl peroxy acids are particularly mentioned as examples. Preferred representatives are (a) peroxybenzoic acid and ring-substituted derivatives thereof, such as alkyl peroxybenzoic acids, but also peroxy-α-naphthqic acid and magnesium monoperphthalate, (b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid and N— nonenylamidopersuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic acid).

Other suitable bleaching agents in dishwasher tablets according to the invention are chlorine- and bromine-releasing substances. Suitable chlorine- or bromine-releasing materials are, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations, such as potassium and sodium. Hydantoin compounds, such as 1,3-dichloro-5,5-dimethyl hydantoin, are also suitable.

The bleaching agents are used in dishwasher detergents in quantities of normally 1 to 30% by weight, preferably 2.5 to 20% by weight and more preferably 5 to 15% by weight, based on the detergent. In the context of the present invention, these quantities are based on the weight of the basic tablet.

Bleach activators which support the effect of the bleaching agents can also be part of the basic tablet. Known bleach activators are compounds which contain one or more N- or O-acyl groups, such as substances from the class of anhydrides, esters, imides and acylated imidazoles or oximes. Examples are tetraacetyl ethylenediamine (TAED), tetraacetyl methylenediamine (TAMD) and tetraacetyl hexylenediamine (TAHD) and also pentaacetyl glucose (PAG), 1,5-diacetyl-2,2-dioxohexaydro-1,3,5-triazine (DADHT) and isatoic anhydride (ISA).

Suitable bleach activators are compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl- or isononanoyl-oxybenzenesulfonate (n- or iso-NOBS), carboxylic anhydrides, more particularly phthalic anhydride, acylated polyhydric alcohols, more particularly triacetin, ethylene glycol diacetate, 2,5-diacetoxy-2,5-dihydrofuran, n-methyl morpholinium acetonitrile methyl sulfate (MMA), enol esters and acetylated sorbitol and mannitol and the mixtures thereof (SORMAN), acylated sugar derivatives, more particularly pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam. Substituted hydrophilic acyl acetals are also preferably used. Combinations of conventional bleach activators may also be used. The bleach activators are normally used in dishwasher detergents in quantities of 0.1 to 20% by weight, preferably in quantities of 0.25 to 15% by weight and most preferably in quantities of 1 to 10% by weight, based on the detergent as a whole. In the context of the invention, the quantities mentioned are based on the weight of the basic tablet.

In addition to or instead of the conventional bleach activators mentioned above, so-called bleach catalysts may also be incorporated in the active substance particles. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium- and copper complexes with nitrogen-containing tripod ligands and cobalt-, iron-, copper- and ruthenium-ammine complexes may also be used as bleach catalysts.

Bleach activators from the group of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or isononanoyl-oxybenzenesulfonate (n- or iso-NOBS), n-methyl morpholinium acetonitrile methyl sulfate (MMA) are preferably used, preferably in quantities of up to 10% by weight, more preferably in quantities of 0.1% by weight to 8% by weight, most preferably in quantities of 2 to 8% by weight and, with particular advantage, in quantities of 2 to 6% by weight, based on the detergent as a whole.

Bleach-boosting transition metal complexes, more particularly containing the central atoms Mn, Fe, Co, Cu, Mo, V, Ti and/or Ru, preferably selected from the group of manganese and/or cobalt salts and/or complexes, more preferably the cobalt (ammine) complexes, cobalt (acetate) complexes, cobalt (carbonyl) complexes, chlorides of cobalt or manganese and manganese sulfate, are also present in typical quantities, preferably in a quantity of up to 5% by weight, more preferably in a quantity of 0.0025% by weight to 1% by weight and most preferably in a quantity of 0.01% by weight to 0.25% by weight, based on the detergent as a whole. In special cases, however, more bleach activator may even be used.

Detergent tablets produced in accordance with the invention which are characterized in that the basic tablet contains bleaching agents from the group of oxygen or halogen bleaching agents, more particularly chlorine bleaching agents, preferably sodium peborate and sodium percarbonate, in quantities of 2 to 25% by weight, preferably 5 to 20% by weight and more preferably 10 to 15% by weight, based on the weight of the basic tablet, represent a preferred embodiment of the present invention.

In another preferred embodiment, the basic tablet and/or the active substance(s) in the cavity contain bleach activators. Detergent tablets in which the basic tablet contains bleach activators from the groups of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or isononanoyl-oxybenzenesulfonate (n- or iso-NOBS), n-methyl morpholinium acetonitrile methyl sulfate (MMA), in quantifies of 0.25 to 15% by weight, preferably in quantities of 0.5% by weight to 10% by weight and more preferably in quantities of 1 to 5% by weight, based on the weight of the basic tablet, are also preferred.

To protect the tableware or the machine itself, the dishwasher tablets produced in accordance with the invention may contain corrosion inhibitors, especially in the basic tablet, silver protectors being particularly important for dishwashing machines. Known corrosion inhibitors may be used. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole is/are particularly preferred. In addition, dishwashing formulations often contain corrosion inhibitors containing active chlorine which are capable of distinctly reducing the corrosion of silver surfaces. Chlorine-free dishwashing detergents contain in particular oxygen- and nitrogen-containing organic redox-active compounds, such as dihydric and trihydric phenols, for example hydroquinone, pyrocatechol, hydroxyhydroquinone, gallic acid, phloroglucinol, pyrogallol and derivatives of these compounds. Salt-like and complex-like inorganic compounds, such as salts of the metals Mn, Ti, Zr, Hf, V, Co and Ce are also frequently used. Of these, the transition metal salts selected from the group of manganese and/or cobalt salts and/or complexes are preferred, cobalt(ammine) complexes, cobalt(acetate) complexes, cobalt(carbonyl) complexes, chlorides of cobalt or manganese and manganese sulfate being particularly preferred. Zinc compounds may also be used to prevent corrosion of tableware.

In preferred dishwasher tablets produced in accordance with the invention, the basic tablet contains silver corrosion inhibitors from the group of triazoles, benzotriazoles, bisbenzotriazoles, aminotriazoles, alkylaminotriazoles and the transition metal salts or complexes, preferably benzotriazole and/or alkyl aminotriazole, in quantities of 0.01 to 5% by weight, preferably in quantities of 0.05 to 4% by weight and more preferably in quantities of 0.5 to 3% by weight, based on the weight of the basic tablet.

However, the cavity filling may of course also contain silver corrosion inhibitors, in which case the basic tablet may also contain silver corrosion inhibitors or may be free from such compounds.

Besides the ingredients mentioned above, other classes of substances are suitable for incorporation in detergents. Thus, detergent tablets produced in accordance with the invention in which the basic tablet additionally contains one or more substances from the groups of enzymes, corrosion inhibitors, film inhibitors, co-builders, dyes and/or perfumes in total quantities of 6 to 30% by weight, preferably 7.5 to 25% by weight and more preferably 10 to 20% by weight, based on the weight of the basic tablet, are preferred.

Besides the constituents mentioned (builder, surfactant, disintegration aid, bleaching agent and bleach activator), the detergent tablets according to the invention may contain other typical detergent ingredients from the group of dyes, perfumes, optical brighteners, enzymes, foam inhibitors, silicone oils, redeposition inhibitors, discoloration inhibitors, dye transfer inhibitors and corrosion inhibitors.

Enzymes suitable for use in the basic tablets are, in particular, those from the classes of hydrolases, such as proteases, esterases, lipases or lipolytic enzymes, amylases, cellulases, glycosyl hydrolases and mixtures thereof. All these hydrolases contribute to the removal of stains, such as protein-containing, fat-containing or starch-containing stains. Oxidoreductases may also be used for bleaching and for inhibiting dye transfer. Enzymes obtained from bacterial strains or fungi, such as Bacillus subtilis, Bacillus licheniformis, Streptomyces griseus, Coprinus cinereus and Humicola insolens and from genetically modified variants are particularly suitable. Proteases of the subtilisin type are preferably used, proteases obtained from Bacillus lentus being particularly preferred. Of particular interest in this regard are enzyme mixtures, for example of protease and amylase or protease and lipase or lipolytic enzymes or of protease, amylase and lipase or lipolytic enzymes or protease, lipase or lipolytic enzymes and cellulase, but especially protease- and/or lipase-containing mixtures or mixtures with lipolytic enzymes. Examples of such lipolytic enzymes are the known cutinases. Peroxidases or oxidases have also been successfully used in some cases. Suitable amylases include in particular α-amylases, isoamylases, pullanases and pectinases.

The enzymes may be adsorbed onto supports and/or encapsulated in membrane materials to protect them against premature decomposition. The percentage content of the enzymes, enzyme mixtures or enzyme granules may be, for example, from about 0.1 to 5% by weight and is preferably from 0.5 to about 4.5% by weight. Preferred detergent tablets according to the invention are characterized in that the basic tablet contains protease and/or amylase.

By virtue of the fact that the detergent tablets according to the invention may contain the enzyme(s) in two basically different regions (in the basic tablet and/or as active substance or active substance mixture in the cavity), it is possible to provide detergents characterized by a very precisely defined enzyme release and effect. The following Table provides an overview of possible enzyme distributions in detergent tablets according to the invention:

| Basic tablet | Cavity |
|---|---|
| Amylase | — |
| Protease | — |
| Lipase | — |
| Amylase + Protease | — |
| Amylase + Lipase | — |
| Protease + Lipase | — |
| Amylase + Protease + Lipase | — |
| — | Amylase |
| — | Protease |
| — | Lipase |
| — | Amylase + Protease |
| — | Amylase + Lipase |
| — | Protease + Lipase |
| — | Amylase + Protease + Lipase |
| Amylase | Amylase |
| Protease | Amylase |
| Amylase + Protease | Amylase |
| Amylase | Protease |
| Protease | Protease |
| Amylase + Protease | Protease |
| Amylase | Amylase + Protease |
| Protease | Amylase + Protease |
| Amylase + Protease | Amylase + Protease |
| Lipase | Amylase |
| Amylase + Lipase | Amylase |
| Protease + Lipase | Amylase |
| Amylase + Protease + Lipase | Amylase |
| Lipase | Protease |
| Amylase + Lipase | Protease |
| Protease + Lipase | Protease |
| Amylase + Protease + Lipase | Protease |
| Lipase | Amylase + Protease |
| Amylase + Lipase | Amylase + Protease |
| Protease + Lipase | Amylase + Protease |
| Amylase + Protease + Lipase | Amylase + Protease |

Dyes and perfumes may be added to the detergent tablets according to the invention both in the basic tablet and in the preparations present in the cavity in order to improve the aesthetic impression created by the products and to provide the consumer not only with the required performance but also with a visually and sensorially “typical and unmistakable” product. Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetiver oil, olibanum oil, galbanum oil and ladanum oil and orange blossom oil, neroli oil, orange peel oil and sandalwood oil.

The perfumes may be directly incorporated in the detergents according to the invention, although it can also be of advantage to apply the perfumes to supports which strengthen the adherence of the perfume to the washing and which provide the textiles with a long-lasting fragrance through a slower release of the perfume. Suitable support materials are, for example, cyclodextrins, the cyclodextrin/perfume complexes optionally being coated with other auxiliaries.

In order to improve their aesthetic impression, the detergents according to the invention (or parts thereof) may be colored with suitable dyes. Preferred dyes, which are not difficult for the expert to choose, have high stability in storage, are not affected by the other ingredients of the detergents or by light and do not have any pronounced substantivity for the substrates to be treated with the detergents, such as textiles, glass, ceramics or plastic tableware, so as not to color them.

The detergent tablets according to the invention may contain one or more optical brightener(s). These substances, which are also known as “whiteners”, are used in modern detergents because even freshly washed and bleached white laundry has a slight yellowish tinge. Optical brighteners are organic dyes which convert part of the invisible UV radiation in sunlight into longer wave blue light. The emission of this blue light fills the “gap” in the light reflected by the fabric, so that a fabric treated with optical brightener appears whiter and brighter to, the eye. Since the action mechanism of brighteners presupposes their absorption onto the fibers, brighteners are differentiated according to the fibers “to be colored”, for example as brighteners for cotton, polyamide or polyester fibers. The commercially available brighteners suitable for incorporation in detergents largely belong to five structural groups, namely: the stilbene, the diphenyl stilbene, the coumarin/quinoline and the diphenyl pyrazoline group and the group where benzoxazole or benzimidazole is combined with conjugated systems. Conventional brighteners are reviewed, for example, in G. Jakobi, A. Löhr “Detergents and Textile Washing”, VCH-Verlag, Weinheim, 1987, pages 94 to 100. Suitable brighteners are, for example, salts of 4,4′-bis-[(4-anilino-6-morpholino-s-triazin-2-yl)-amino]-stilbene-2,2′-disulfonic acid or compounds of similar structure which, instead of the morpholino group, contain a diethanolamino group, a methylamino group, an anilino group or a 2-methoxyethylamino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned above may also be used.

In addition, the detergent tablets according to the invention may also contain components with a positive effect on the removal of oil and fats from textiles by washing (so-called soil repellents). This effect becomes particularly clear when a textile which has already been repeatedly washed with a detergent according to the invention containing this oil- and fat-dissolving component is soiled. Preferred oil- and fat-dissolving components include, for example, nonionic cellulose ethers, such as methyl cellulose and methyl hydroxypropyl cellulose containing 15 to 30% by weight of methoxyl groups and 1 to 15% by weight of hydroxypropoxyl groups, based on the nonionic cellulose ether, and the polymers of phthalic acid and/or terephthalic acid known from the prior art or derivatives thereof, more particularly polymers of ethylene terephthalates and/or polyethylene glycol terephthalates or anionically and/or nonionically modified derivatives thereof. Of these, the sulfonated derivatives of phthalic acid and terephthalic acid polymers are particularly preferred.

Foam inhibitors suitable for use in the detergents according to the invention are, for example, soaps, paraffins and silicone oils which may optionally be applied to carrier materials.

The function of redeposition inhibitors is to keep the soil detached from the fibers suspended in the wash liquor and thus to prevent the soil from being reabsorbed by the washing. Suitable redeposition inhibitors are water-soluble, generally organic colloids, for example the water-soluble salts of polymeric carboxylic acids, glue, gelatine, salts of ether carboxylic acids or ether sulfonic acids of starch or cellulose or salts of acidic sulfuric acid esters of cellulose or starch. Water-soluble polyamides containing acidic groups are also suitable for this purpose. Soluble starch preparations and other starch products than those mentioned above, for example degraded starch, aldehyde starches, etc., may also be used. Polyvinyl pyrrolidone is also suitable. However, cellulose ethers, such as carboxymethyl cellulose (sodium salt), methyl cellulose, hydroxyalkyl cellulose, and mixed ethers, such as methyl hydroxyethyl cellulose, methyl hydroxypropyl cellulose, methyl carboxymethyl cellulose and mixtures thereof are preferably used, for example in quantities of 0.1 to 5% by weight, based on the detergent.

Since sheet-form textiles, more particularly of rayon, rayon staple, cotton and blends thereof, can tend to crease because the individual fibers are sensitive to sagging, kinking, pressing and squeezing transversely of the fiber direction, the compositions according to the invention may contain synthetic anticrease agents, including for example synthetic products based on fatty acids, fatty acid esters, fatty acid amides, alkylol esters, alkylol amides or fatty alcohols, which are generally reacted with ethylene oxide, or products based on lecithin or modified phosphoric acid esters.

To control microorganisms, the compositions according to the invention may contain antimicrobial agents. According to the antimicrobial spectrum and the action mechanism, antimicrobial agents may be divided into bacteriostatic agents and bactericides, fungistatic agents and fungicides, etc. Important representatives of these groups are, for example, benzalkonium chlorides, alkylaryl sulfates, halophenols and phenol mercury acetate, although these compounds may also be absent altogether.

In order to prevent unwanted changes in the compositions and/or the fabrics treated with them attributable to the effects of oxygen and other oxidative processes, the compositions may contain antioxidants. This class of compounds includes, for example, substituted phenols, hydroquinones, pyrocatechols and aromatic amines and also organic sulfides, polysulfides, dithiocarbamates, phosphites and phosphonates.

Wearing comfort can be increased by the additional use of antistatic agents which are additionally incorporated in the detergents according to the invention. Antistatic agents increase surface conductivity and thus provide for the improved dissipation of any charges which have built up. External antistatic agents are generally substances containing at least one hydrophilic molecule ligand and form a more or less hygroscopic film on the surfaces. These generally interfacially active antistatic agents may be divided into nitrogen-containing antistatics (amines, amides, quaternary ammonium compounds), phosphorus-containing antistatics (phosphoric acid esters) and sulfur-containing antistatics (alkyl sulfonates, alkyl sulfates). External antistatic agents are described, for example, in patent applications FR 1,156,513, GB 873,214 and GB 839,407. The lauryl (or stearyl) dimethyl benzyl ammonium chlorides disclosed therein are suitable as antistatic agents for textiles and as detergent additives and additionally develop a conditioning effect.

In order to improve the water absorption capacity and rewettability of the treated textiles and to make them easier to iron, silicone derivatives, for example, may be used in the compositions according to the invention. Silicone derivatives additionally improve the rinsing out behavior of the compositions through their foam-inhibiting properties. Preferred silicone derivatives are, for example, polydialkyl and alkylaryl siloxanes where the alkyl groups contain 1 to 5 carbon atoms and are completely or partly fluorinated. Preferred silicones are polydimethyl siloxanes which may optionally be derivatized and, in that case, are aminofunctional or quaternized or contain Si—OH—, Si—H— and/or Si—Cl bonds. The preferred silicones have viscosities at 25° C. of 100 to 100,000 centistokes and may be used in quantities of 0.2 to 5% by weight, based on the detergent as a whole.

Finally, the compositions according to the invention may also contain UV filters which are absorbed onto the treated textiles and which improve the light stability of the fibers. Compounds which have these desirable properties are, for example, the compounds acting by “radiationless” deactivation and derivatives of benzophenone with substituents in the 2 position and/or 4 position. Substituted benzotriazoles, 3-phenyl-substituted acrylates (cinnamic acid derivatives), optionally with cyano groups in the 2-position, salicylates, organic Ni complexes and natural substances, such as umbelliferone and the body's own urocanic acid.

The ingredients described above may of course also be incorporated in the cavity filling. Preferred laundry/dishwasher detergent tablets according to the invention are characterized in that the active substance contained in the space defined by the film and the tablet contains at least one active substance from the group of enzymes, surfactants, soil-release polymers, disintegration aids, bleaching agents, bleach activators, bleach catalysts, silver corrosion inhibitors and mixtures thereof.

Through the division of the laundry/dishwasher detergent tablets produced in accordance with the invention into basic tablets and active substance(s) or active substance mixtures or preparation(s) present in the cavity, ingredients can be separated from one another which may be used either to separate incompatible ingredients to improve their stability in storage or for the controlled release of certain active substances. In preferred laundry/dishwasher detergent tablets, the basic tablet or the active substance present in the space defined by the film and the tablet contains bleaching agents while the other region of the tablet contains bleach activators.

Other preferred laundry/dishwasher detergent tablets produced in accordance with the invention are characterized in that the basic tablet or the active substance present in the space defined by the film and the tablet contains bleaching agents while the other region of the tablet contains enzymes.

Bleaching agent and corrosion inhibitors or silver corrosion inhibitors can also be separated. Laundry/dishwasher detergent tablets in which the basic tablet or the active substance present in the space defined by the film and the tablet contains bleaching agents while the other region of the tablet contains corrosion inhibitors are also preferred.

Last but not least, laundry/dishwasher tablets in which the basic tablet or the active substance contained in the space defined by the film and the tablet contains bleaching agents while the other region of the tablet contains surfactants, preferably nonionic surfactants and more preferably alkoxylated alcohols containing 10 to 24 carbon atoms and 1 to 5 alkylene oxide units, are also preferred.

With all the ingredients mentioned above, advantageous properties can result from their separation from other ingredients or from their being made up together with certain other ingredients. In the tablets according to the invention, the individual regions may also have different contents of the same ingredient, which can afford advantages. Preferred detergent tablets are characterized in that the basic tablet and the active substance present in the space defined by the film and the tablet contain the same active substance in different quantities. The expression “different quantities” does not relate to the absolute quantity of the ingredient in the particular part of the tablet, but rather to the relative quantity, based on the weight of the phase, i.e. represents a percentage by weight, based on the individual region, i.e. the basic tablet or the cavity filling.

The active substance optionally incorporated in the cavity is preferably particulate. The expression “active substance” in the context of the present, invention is not confined to pure substances, but instead characterizes pure active substances, active-substance mixtures and preparations so that there are no limits to the freedom of formulation. If particulate substances are incorporated in the cavities, they preferably satisfy certain particle size criteria so that preferred detergent tablets are characterized in that the active substance present in the space defined by the film and the tablet has particle sizes of 100 to 5000 μm, preferably in the range from 150 to 2500 μm, more preferably in the range from 200 to 2000 μm and most preferably in the range from 400 to 1600 μm.

As already mentioned, the filling to be optionally introduced into the cavity is preferably solid, particulate fillings being particularly preferred. If the cavities in the tablets are filled with particulate compositions, processes where the particulate composition(s) in step b) have a bulk density of at least 500 g/l, preferably at least 600 g/l and more particularly of at least 700 g/l are preferred.

According to the invention, the film which seals the cavity(ies) is punched out to match the size of the basic tablet surface and held by vacuum. “To match the size of the basic tablet surface” means that the film completely covers and seals the cavity. Preferably, the film does not project beyond the edge of the basic tablet—more for aesthetic than technical reasons. Where the upper surface is large with a small cavity, the film does not have to completely cover the entire upper surface. In such a case, a sealing rim around the cavity can be sufficient, the width of the sealing rim preferably being at least 1 mm.

However, in preferred embodiments of the present invention—this is particularly the case where the cavity openings make up more than one third of the upper surface area of the basic tablet—the label punched out is cut to size so that it completely covers the upper surface.

The label punched out is held by vacuum. This is preferably done by the robot which was also responsible for stamping. The vacuum supports the formation of a smooth film surface, which stays smooth even after the application of adhesive, and is in the range from 100 to 1,000 mbar, preferably in the range from 250 to 950 mbar and more particularly in the range from 500 to 900 mbar.

The film seals the cavity and thus stops the filling from dropping out. To this end, the film has to be suitably fixed to the mold. In special embodiments, this can be done by positive geometric connections, although application of the film by adhesive is the preferred method for industrial-scale production. Prepared films with self-adhesive properties may be used for this purpose. These films are adhesively applied like “stickers” to the upper surface of the filled tablet. However, in view of the price of such films, processes according to the invention where the surface of the basic tablet and/or the underside of the labels is/are coated with adhesive and the labels are subsequently applied to the basic tablet are preferred.

The film preferably consists of water-soluble material. The polymers used as film materials may consist of a single material or of a blend of different materials. Preferred film materials belong to the group of (optionally acetalized) polyvinyl alcohol (PVAL) and/or PVAL copolymers, polyvinyl pyrrolidone, polyethylene oxide, polyethylene glycol, gelatin and/or copolymers and mixtures thereof.

According to the invention, polyvinyl alcohols are particularly preferred water-soluble polymers. Polyvinyl alcohols, referred to in short as PVALs and occasionally as PVOHs, are polymers with the following general structure: 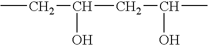
which may also contain structural units of the following type: 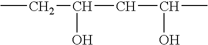
in small amounts (ca. 2%).

Commercially available polyvinyl alcohols, which are marketed as white-yellowish powders or granules with degrees of polymerization of ca. 500 to 2,500 (molecular weights of ca. 4,000 to 100,000 g/mol), have degrees of hydrolysis of 98-99 or 87-89 mol-%, i.e. still have a residual content of acetyl groups. The polyvinyl alcohols are characterized by their manufacturers by the degree of polymerization of the starting polymer, the degree of hydrolysis, the saponification number or the solution viscosity.

Depending on their degree of hydrolysis, polyvinyl alcohols are soluble in water and in a few highly polar organic solvents (formamide, dimethyl formamide, dimethyl sulfoxide); they are not affected by (chlorinated) hydrocarbons, esters, fats or oils. Polyvinyl alcohols are classified as toxicologically safe and are at least partly biodegradable. Their solubility in water can be reduced by aftertreatment with aldehydes (acetalization), by complexing with Ni or Cu salts or by treatment with dichromates, boric acid or borax. Polyvinyl alcohol is largely impenetrable to gases such as oxygen, nitrogen, helium, hydrogen, carbon dioxide but allows water vapor through.

According to the invention, preferred processes are characterized in that the film material comprises polyvinyl alcohols and/or PVAL copolyemers with a degree of hydrolysis of 70 to 100 mol-%, preferably 80 to 90 mol-%, more preferably 81 to 89 mol-% and most preferably 82 to 88 mol-%.

Polyvinyl alcohols with a certain molecular weight range are preferably used, preferred processes according to the invention being characterized in that the film comprises polyvinyl alcohols and/or PVAL copolymers with a molecular weight in the range from 3,500 to 100,000 gmol⁻¹, preferably in the range from 10,000 to 90,000 gmol⁻¹, more preferably in the range from 12,000 to 80,000 gmol¹ and most preferably in the range from 13,000 to 70,000 gmol^{-1.}

The degree of polymerization of such preferred polyvinyl alcohols is between about 200 and about 2100, preferably between about 220 and about 1890, more preferably between about 240 and about 1680 and most preferably between about 260 and about 1500.

Preferred processes according to the invention are characterized in that the film contains polyvinyl alcohols and/or PVAL copolymers of which the average degree of polymerization is between 80 and 700, preferably between 150 and 400 and more particularly between 180 and 300 and/or of which the molecular weight ratio MW (50%) to MW (90%) is between 0.3 and 1, preferably between 0.4 and 0.8 and more particularly between 0.45 and 0.6.

The polyvinyl alcohols described above are commercially available on a wide scale, for example under the name of Mowiol® (Clariant). Polyvinyl alcohols particularly suitable for the purposes of the present invention are, for example, Mowiol® 3-83, Mowiol® 4-88, Mowiol® 5-88 and Mowiol® 8-88.

Other polyvinyl alcohols particularly suitable as film materials are listed in the following Table:

| | Degree of | Molecular | Melting |
|---|---|---|---|
| | hydrolysis | weight | point |
| Name | [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Other polyvinyl alcohols suitable as the film material are ELVANOL® 51-05, 52-22, 50-42, 85-82, 75-15, T-25, T-66, 90-50 (Trade Marks of Du Pont), ALCOTEX® 72.5, 78, B72, F80/40, F88/4, F88/26, F88/40, F88/47 (Trade Marks of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (Trade Marks of Nippon Gohsei K.K.). ERKOL types (Wacker) are also suitable.

Another preferred group of water-soluble polymers which may be used as film material in accordance with the invention are the polyvinyl pyrrolidones. Polyvinyl pyrrolidones are marketed, for example, under the name of Luviskol® (BASF). Polyvinyl pyrrolidones [poly(1-vinyl-2-pyrrolidinones)], PVPs for short, are polymers corresponding to general formula (IV): 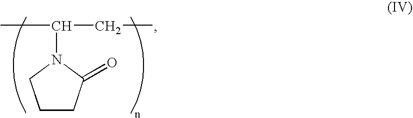
which are obtained by radical polymerization of 1-vinyl pyrrolidone by solution or suspension polymerization using radical formers (peroxides, azo compounds) as initiators. The ionic polymerization of the monomer only gives products of low molecular weight. Commercially available polyvinyl pyrrolidones have molecular weights of about 2,500 to 750,000 g/mol which are characterized by expressing the K values and—depending on their K value—have glass transition temperatures of 130 to 175° C. They are marketed as white hygroscopic powders or as aqueous solutions. Polyvinyl pyrrolidones are readily soluble in water and in a number of organic solvents (alcohols, ketones, glacial acetic acid, chlorinated hydrocarbons, phenols, etc.).

Copolymers of vinyl pyrrolidone with other monomers, more especially the vinyl pyrrolidone/vinyl acetate copolymers marketed, for example, under the registered name of Luviskol® (BASF), are also suitable. Luviskol® VA 64 and Luviskol® VA 73, both vinyl pyrrolidone/vinyl acetate copolymers, are particularly preferred nonionic polymers.

The vinyl ester polymers are polymers obtainable from vinyl esters containing a group corresponding to formula (V): 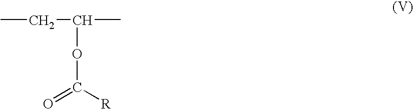
as the characteristic basic unit of the macromolecules. Of these, the vinyl acetate polymers (R═CH₃) with polyvinyl acetates, as by far the most important representatives, have the greatest commercial significance.

The polymerization of the vinyl esters is carried out by various radical polymerization processes (solution polymerization, suspension polymerization, emulsion polymerization, bulk polymerization). Copolymers of vinyl acetate with vinyl pyrrolidone contain monomer units corresponding to formulae (IV) and (V).

Other suitable water-soluble polymers are the polyethylene glycols (polyethylene oxides) which are known in short as PEGs. PEGs are polymers of ethylene glycol which correspond to general formula (VI):
H—(O—CH₂—CH₂)ₙ—OH (VI)
where n may assume a value of 5 to >100,000.

On an industrial scale, PEGs are produced by anionic ring-opening polymerization of ethylene oxide (oxirane), generally in the presence of small quantities of water. Depending on the how the reaction is conducted, they have molecular, weights in the range from ca. 200 to 5,000,000 g/mol which corresponds to degrees of polymerization of ca. 5 to >100,000.

The products with molecular weights below ca. 25,000 g/mol are liquid at room temperature and are called polyethylene glycols proper (PEGs for short). These short-chain PEGs may be added in particular to other water-soluble polymers, for example polyvinyl alcohols or cellulose ethers, as plasticizers. The polyethylene glycols solid at room temperature usable in accordance with the invention are referred to as polyethylene oxides (PEOXs for short). High molecular weight polyethylene oxides have an extremely low concentration of reactive terminal hydroxy groups and, hence, possess only weak glycol properties.

According to the invention, another suitable film material is gelatin which is preferably used together with other polymers. Gelatin is a polypeptide (molecular weight ca. 15,000->250,000 g/mol) which is mainly obtained by hydrolysis of the collagen present in the skin and bones of animals under acidic or alkaline conditions. The amino acid composition of gelatin largely corresponds to that of the collagen from which it was obtained and varies according to its provenance. The use of gelatin as a water-soluble capsule material is particularly widespread in pharmacy (hard or soft gelatin capsules). Gelatin is used to only a limited extent in film form on account of its high price as compared with the polymers mentioned above.

Other water-soluble polymers suitable as film material in accordance with the invention are described in the following:
Cellulose ethers, such as hydroxypropyl cellulose, hydroxyethyl cellulose and methyl hydroxypropyl cellulose, which are marketed for example under the registered names of Culminal® and Benecel® (AQUALON). Cellulose ethers correspond to general formula (VI): 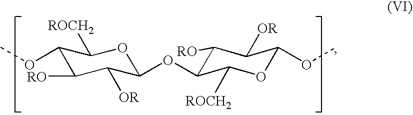
in which R represents H or an alkyl, alkenyl, alkinyl, aryl or alkylaryl group. In preferred products, at least one R in formula (III) stands for —CH₂CH₂CH₂—OH or —CH₂CH₂—OH. On an industrial scale, cellulose ethers are produced by etherification of alkali metal cellulose (for example with ethylene oxide). Cellulose ethers are characterized by the average degree of substitution DS or the molar degree of substitution MS which indicates how many hydroxy groups of an anhydroglucose unit of the cellulose have reacted with the etherifying agent or how many mol the etherifying agent on average have been added onto one anhydroglucose unit. Hydroxyethyl celluloses are soluble in water where they have a DS of about 0.6 or higher or an MS of about 1 or higher. Commercially available hydroxyethyl or hydroxypropyl celluloses have degrees of substitution of 0.85 to 1.35 (DS) or 1.5 to 3 (MS). Hydroxyethyl and hydroxypropyl celluloses are marketed as yellowish-white, odorless and tasteless powders with various degrees of polymerization. Hydroxyethyl and hydroxypropyl celluloses are soluble in cold and hot water and in certain (water-containing) organic solvents, but are insoluble in most (water-free) organic solvents. Their aqueous solutions are relatively non-sensitive to changes in pH or to the addition of an electrolyte.

Other polymers suitable for the purposes of the invention are water-soluble “amphopolymers”. “Amphopolymers” is the generic term for amphoteric polymers, i.e. polymers which contain both free amino groups and free —COOH or —SO₃H groups in the molecule and which are capable of forming inner salts, zwitterionic polymers which contain quaternary ammonium groups and —COO⁻ or —SO₃⁻ groups in the molecule, and for polymers which contain —COOH or —SO₃H groups and quaternary ammonium groups. One example of an amphopolymer suitable for use in accordance with the invention is the acrylic resin obtainable under the name of Amphomer®, which is a copolymer of tert.butyl aminoethyl methacrylate, N-(1,1,3,3-tetramethylbutyl)acrylamide and two or more monomers from the group consisting of acrylic acid, methacrylic acid and simple esters thereof. Other preferred amphopolymers consist of unsaturated carboxylic acids (for example acrylic and methacrylic acid), cationically derivatized unsaturated carboxylic acids (for example acrylamidopropyl trimethyl ammonium chloride) and optionally other ionic or nonionic monomers. According to the invention, terpolymers of acrylic acid, methyl acrylate and methacrylamidopropyl trimonium chloride, which are commercially available under the name of Merquat® 2001 N, are particularly preferred amphopolymers. Other suitable amphoteric polymers are, for example, the octyl acrylamide/methyl methacrylate/tert.butylaminoethyl methacrylate/2-hydroxypropyl methacrylate copolymers obtainable under the names of Amphomer®, and Amphomer® LV-71 (DELFT NATIONAL).

Water-soluble anionic polymers suitable for the purposes of the present invention include:
Vinyl acetate/crotonic acid copolymers which are marketed, for example, under the names of Resyn® (NATIONAL STARCH), Luviset® (BASF) and Gafset® (GAF).
Besides monomer units corresponding to formula (II) above, these polymers also contain monomer units corresponding to general formula (VII):
   [—CH(CH₃)—CH(COOH)—]ₙ (VII)
Vinyl pyrrolidone/vinyl acrylate copolymers obtainable, for example, under the registered name of Luviflex® (BASF). A preferred polymer is the vinyl pyrrolidone/acrylate terpolymer obtainable under the name of Luviflex® VBM-35 (BASF).
Acrylic acid/ethylacrylate/N-tert.butyl acrylamide terpolymers which are marketed, for example, under the name of Ultrahold® strong (BASF).

Graft polymers of vinyl esters, esters of acrylic acid or methacrylic acid individually or in admixture copolymerized with crotonic acid, acrylic acid or methacrylic acid with polyalkylene oxides and/or polyalkylene glycols.

Corresponding grafted polymers of vinyl esters, esters of acrylic acid or methacrylic acid individually or in admixture with other copolymerizable compounds on polyalkylene glycols are obtained by high-temperature polymerization in homogeneous phase by stirring the polyalkylene glycols into the monomers, i.e. vinyl esters, esters of acrylic or methacrylic acid, in the presence of radical formers.

Suitable vinyl esters are, for example, vinyl acetate, vinyl propionate, vinyl butyrate, vinyl benzoate while suitable esters of acrylic or methacrylic acid are those obtainable with low molecular weight aliphatic alcohols, i.e. in particular ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol; 3-methyl-2-butanol, 2-methyl-2-butanol, 2-methyl-1-butanol, 1-hexanol.

Polypropylene glycols (PPGs) are polymers of propylene glycol which correspond to general formula (IX): 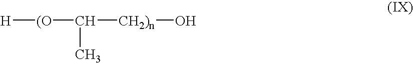
where n may assume a value of 1 (propylene glycol) to several thousand. Di-, tri- and tetrapropylene glycol, i.e. representatives where n=2, 3 and 4 in formula VI, are of particular commercial significance.

More particularly, the vinyl acetate copolymers grafted onto polyethylene glycols and the polymers of vinyl acetate and crotonic acid grafted onto polyethylene glycols may be used.
Grafted and crosslinked copolymers from the copolymerization of
i) at least one monomer of the nonionic type,
ii) at least one monomer of the ionic type,
iii) polyethylene glycol and
iv) a crosslinking agent.

The polyethylene glycol used has a molecular weight of 200 to several million and preferably in the range from 300 to 30,000.

The nonionic monomers may be of various types, among which the following are preferred: vinyl acetate, vinyl stearate, vinyl laurate, vinyl propionate, allyl stearate, allyl laurate, diethyl maleate, allyl acetate, methyl methacrylate, cetyl vinyl ether, stearyl vinyl ether and 1-hexene.

The nonionic monomers may also be of various types, among which crotonic acid, allyloxyacetic acid, vinyl acetic acid, maleic acid, acrylic acid and methacrylic acid are present with particular advantage in the graft polymers.

Preferred crosslinking agents are ethylene glycol dimethacrylate, diallyl phthalate, ortho-, meta- and para-divinyl benzene, tetraallyloxy ethane and polyallyl saccharoses containing 2 to 5 allyl groups per molecule of saccharin.

The grafted and crosslinked copolymers described above are preferably formed from:
i) 5 to 85% by weight of at least one monomer of the nonionic type,
ii) 3 to 80% by weight of at least one monomer of the ionic type,
iii) 2 to 50% by weight and preferably 5 to 30% by weight of polyethylene glycol and
iv) 0.1 to 8% by weight of a crosslinking agent, the percentage of the crosslinking agent being determined by the ratio of the total weights of i), ii) and iii).
Copolymers obtained by copolymerization of at least one monomer from each of the following three groups:
i) esters of unsaturated alcohols and short-chain saturated carboxylic acids and/or esters of short-chain saturated alcohols and unsaturated carboxylic acids,
ii) unsaturated carboxylic acids,
iii) esters of long-chain carboxylic acids and unsaturated alcohols and/or esters of the carboxylic acids of group ii) with saturated or unsaturated, linear or branched C₈₋₁₈ alcohol.

Short-chain carboxylic acids or alcohols in the context of the present invention are understood to be those containing 1 to 8 carbon atoms, the carbon chains of these compounds optionally being interrupted by two-bond hetero groups, such as —O—, —NH—, —S—.
Terpolymers of crotonic acid, vinyl acetate and an allyl or methallyl ester.

These terpolymers contain monomer units corresponding to general formulae (IV) and (VI) (see above) and monomer units of one or more allyl or methallyl esters corresponding to formula (X): 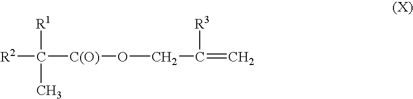
where R³ represents —H or —CH₃, R² represents —CH₃ or —CH(CH₃)₂ and R¹ represents —CH₃ or is a saturated, linear or branched C₁₋₆ alkyl group and the sum of the carbon atoms in the substituents R¹ and R² is preferably 7, 6, 5, 4, 3 or 2.

The terpolymers mentioned above preferably result from the copolymerization of 7 to 12% by weight of crotonic acid, 65 to 86% by weight and preferably 71 to 83% by weight of vinyl acetate and 8 to 20% by weight and preferably 10 to 17% by weight of allyl or methallyl esters corresponding to formula (VII).
Tetrapolymers and pentapolymers of
i) crotonic acid or allyloxyacetic acid,
ii) vinyl acetate or vinyl propionate,
iii) branched allyl or methallyl esters,
iv) vinyl ethers, vinyl esters or straight-chain allyl or methallyl esters.
Crotonic acid copolymers with one or more monomers from the group consisting of ethylene, vinyl benzene, vinyl methyl ether, acrylamide and water-soluble salts thereof.
Terpolymers of vinyl acetate, crotonic acid and vinyl esters of a saturated aliphatic monocarboxylic acid branched in the α-position.

Other polymers usable with advantage as film material are cationic polymers. Among the cationic polymers, permanently cationic polymers are preferred. In the context of the invention, “permanently cationic” polymers are polymers which contain a cationic group irrespective of the pH value. Such polymers are generally polymers which contain a quaternary nitrogen atom, for example in the form of an ammonium group.

The following are examples of preferred cationic polymers:
Quaternized cellulose derivatives commercially obtainable under the names of Celquat® and Polymer JR®. The compounds Celquat® H 100, Celquat® L 200 and Polymer JR® 400 are preferred quaternized cellulose derivatives.
Polysiloxanes containing quaternary groups such as, for example, the commercially available products Q2-7224 (manufacturer: Dow Corning; a stabilized trimethyl silylamodimethicone), Dow Corning® 929 Emulsion (containing a hydroxylamino-modified silicone which is also known as amodimethicone), SM-2059 (manufacturer: General Electric), SLM-55067 (manufacturer: Wacker) and Abil®-Quat 3270 and 3272 (manufacturer: Th. Goldschmidt; diquaternary polydimethyl siloxanes, quaternium-80).
Cationic guar derivatives such as, in particular, the products marketed under the names of Cosmedia®Guar and Jaguar®.
Polymeric dimethyl diallylammonium salts and copolymers thereof with esters and amides of acrylic acid and methacrylic acid. The products commercially obtainable under the names of Merquat® 100 (poly(dimethyl diallylammonium chloride)) and Merquat® 550 (dimethyl diallylammonium chloride/acrylamide copolymer) are examples of such cationic polymers.
Copolymers of vinyl pyrrolidone with quaternized derivatives of dialkyl aminoacrylate and methacrylate, such as for example vinyl pyrrolidone/dimethylaminomethacrylate copolymers quaternized with diethyl sulfate. Compounds such as these are commercially available under the names of Gafquat® 734 and Gafquat® 755.
Vinyl pyrrolidone/methoimidazolinium chloride copolymers as marketed under the name of Luviquat®.
Quaternized polyvinyl alcohol
and the polymers containing quaternary nitrogen atoms in the main polymer chain known, by the names of
polyquaternium 2,
polyquaternium 17,
polyquaternium 18 and
polyquaternium 27.

The names of the above-mentioned polymers are based on the so-called INCI nomenclature: particulars can be found in the CTFA International Cosmetic Ingredient Dictionary and Handbook, 5^{th} Edition, The Cosmetic, Toiletry and Fragrance Association, Washington, 1997, to which reference is expressly made here.

According to the invention, preferred cationic polymers are quaternized cellulose derivatives and polymeric dimethyl diallylammonium salts and copolymers thereof. Cationic cellulose derivatives, more particularly the commercial product Polymer® JR 400, are most particularly preferred cationic polymers.

Together with the tablet formed with at least one cavity, the film adhesively applied to the basic tablet forms the detergent tablet produced in accordance with the invention. In the case of sealed cavity tablets, the structure of the tablets produced in accordance with the invention is reminiscent of a “drum” where one cavity is sealed by a film.

Where liquid, gel-form or paste-like active substances or active substance mixtures are incorporated, the compositions of the basic tablet and the film have to be adapted to the filling in order to avoid premature destruction of the film or loss of active substance through the tablet. Where solid substances are incorporated in the cavity, this is only necessary to a limited extent (chemical incompatibilities), so that preferred detergent tablets produced in accordance with the invention contain more active substances in particulate form, preferably in powder, granular, extruded, pelleted, prilled, flaked or tabletted form.

The cavity sealed by the film can be completely filled with more active substance. However, the cavity may also be only partly filled before sealing to enable the particles or liquids introduced to move within the cavity. Attractive optical effects can be achieved by using relatively large, regularly shaped particles as the filling. In this case, preferred processes for the production of detergent tablets are characterized in that the ratio by volume of the space enclosed by the film and the basic tablet to the active substance accommodated in that space is 1:1 to 100:1, preferably 1.1:1 to 50:1, more preferably 1.2:1 to 25:1 and most preferably 1.3:1 to 10:1. In this terminology, a ratio by volume of 1:1 means that the cavity is completely filled.

Depending on the size of the cavity, the density of the basic tablet, the density of the active substance in the cavity and the filling level of the cavity, the percentage of other active substance in the cavity can make different percentage contributions to the tablet as a whole. In this case, preferred processes for the production of detergent tablets are characterized in that the ratio by weight of basic tablet to the active substance contained in the space enclosed by the film and the basic tablet is 1:1 to 100:1, preferably 2:1 to 80:1, more preferably 3:1 to 50:1 and, more particularly, 4:1 to 30:1. The ratio by weight defined above is the ratio of the weight of unfilled basic tablet to the weight of the filling. The weight of the film is not included in this calculation.

The time at which the substance accommodated in the cavity is released can be determined in advance by suitable formulation of the tablet and the film material. For example, the film can be formulated to dissolve almost suddenly, so that the active substance accommodated in the cavity is released into the wash liquor at the very beginning of the washing/dishwashing program. Alternatively, the film can be formulated to dissolve so slowly that the tablet dissolves first and releases the active substance accommodated in the cavity.

Depending on this release mechanism, it is possible, for example, to produce tablets where the active substance accommodated in the cavity is dissolved in the wash liquor before or after the constituents of the tablet dissolve. Thus, on the one hand, the production of detergent tablets which are characterized in that the active substance accommodated in the space enclosed by the film and the tablet dissolves more quickly than the basic tablet is preferred.

However, detergent tablets where the active substance accommodated in the space enclosed by the film and the tablet dissolves more slowly than the basic tablet also represent preferred embodiments of the present invention.

In order to adjust the acceleration of the filled tablets in such a way that the filling is prevented from leaking out onto the upper surface of the tablet, it is advisable to take appropriate design measures. Since the filling station and the automatic stamping and sealing unit are generally stationary, the arrangement by which the tablets are moved has to be suitably designed. To this end, preferred processes according to the invention are characterized in that the basic tablets produced in step a) are delivered to the filling and sealing station on a conveyor belt travelling at a speed of 0.01 to 1 m/s, preferably 0.02 to 0.5 m/s, more preferably 0.03 to 0.3 m/s and most preferably 0.05 to 0.2 m/s.

In order to guarantee production on an industrial scale and still to be able to operate at low conveyor speeds, it has proved to be of advantage to fill several basic tablets at the same time and then to seal them at the same time. This can be done, for example, by filling and sealing stations which comprise several filling and sealing units in the direction of travel of the conveyor belt. However, it is of greater advantage if the filling and sealing stations have several filling and sealing units transversely of the direction of travel of the conveyor belt. To this end, several tablets have to be arranged beside one another on the conveyor belt. Preferred processes according to the invention are characterized in that the basic tablets produced in step a) are arranged beside and behind one another on a tray so that several basic tablets can be filled at the same time and then sealed at the same time.

In order to guarantee high throughputs, as many basic tablets as possible are preferably arranged beside one another. In this respect, particularly preferred processes according to the invention are characterized in that at least 4, preferably at least 6, more preferably at least 10 and most preferably at least 12 basic tablets are arranged beside one another.

In practical trials, arrangements where, for example, 12, 13, 14, 15, 16, 17, 18, 19 or 20 basic tablets are arranged beside one another have proved to be advantageous. The arrangement and exact positioning of the basic tablets can be optimized by placing the tablets after their production on a tray formed with depressions for the tablets. Such trays have a corresponding number of depressions transversely of the direction of travel of the conveyor and may accommodate, for example, one, two, three, four, five, six, seven, eight, nine or ten tablets in the direction of travel of the conveyor belt. With regard to the dimensions of the filling and sealing stations, which advantageously fill and seal all the basic tablets on a tray in this embodiment of the process, trays which accommodate 18×4 tablets have proved to be particularly useful.

The filling of the tablets with active substance(s), i.e. with liquid(s) and/or particulate preparations, is preferably also carried out in such a way that several basic tablets are filled at the same time. To this end, preferred processes according to the invention are characterized in that the basic tablets are filled by a filling machine operating at a filling rate of 5 to 30, preferably 10 to 25 and more particularly 15 to 20 trays per minute.

In the case of the preferred 18×4 tray, 1440 tablets per minute, for example, can be filled at a filling rate of 20 trays per minute.

As already mentioned, in processes where several tablets are arranged in groups, one group of basic tablets can advantageously be filled simultaneously and then sealed. Accordingly, preferred processes according to the invention are characterized in that several labels are punched out at the same time, held by vacuum and then stuck on after application of adhesive to the tablet surface and/or to the underside of the labels.

The adhesive may be applied, for example, by applicator rollers continuously supplied with adhesive on one side. The upper tablet surface or the underside of the film is then moved past the rotating applicator roller and thus coated with adhesive. Accordingly, in one embodiment of the present invention, the upper surface of the filled basic tablets is coated with adhesive by applicator rollers.

Depending on the composition and production of the basic tablets, the tablet surface is more or less rough, so that the application of adhesive to the upper tablet surface can be technically difficult. In addition, powder residues on the tablet surface can soil the adhesive roller and interfere with the operation of the machine and with the adhesion of the film to the tablet. Accordingly, in a preferred embodiment of the present invention, the labels are coated with adhesive and then applied to the filled basic tablets. Here, preferred processes according to the invention are characterized in that the underside of the labels held by vacuum is coated with adhesive by applicator rollers.

An alternative to applicator rollers is a casting machine which casts or injects a strand of adhesive around the filled cavity. Since direct contact between the machine and the tablet surface is not necessary here, this variant of the process is another way of avoiding the above-mentioned problems involved with rough or “dusty” basic tablets.

Accordingly, other preferred variants of the process according to the invention are characterized in that the upper surface of the filled basic tablets is coated with adhesive by a casting machine which is capable under computer control of applying any linear form to that surface.

Suitable adhesives are any materials which impart sufficient adhesiveness to the tablet surfaces to which they are applied, so that the films applied in the subsequent process step adhere permanently to the surface. In principle, any of the substances mentioned in the relevant literature and particularly in relevant textbooks may be used for this purpose, the application of melts which have an adhesion-promoting effect at elevated temperature, but are solid, i.e. no longer tacky, after cooling being particularly important in the context of the present invention.

Particularly preferred adhesives for the purposes of the present invention are solutions of polyvinyl alcohols (see above) and dispersions of polyacrylates. The quantity of adhesive applied per tablet can vary according to the size of the tablet, its composition and its surface roughness and, in preferred processes according to the invention, is between 0.05 and 0.3 gram per tablet.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A process for making detergent tablets comprising the steps of:
a) forming a shaped body having at least one cavity;
b) filling the cavity with one or more active substances in liquid, gel, paste, or solid form; and
c) sealing the filled cavity with a film,
wherein the film comprises in whole or in part a label that is applied to the tablet.

2. The process of claim 1, wherein the shaped body is formed in step a) by tabletting a particulate premix.

3. The process of claim 1, wherein the shaped body is formed in step a) by thermoforming and/or casting and/or injection molding and/or blow molding a water-soluble or water-dispersible polymer or polymer mixture.

4. The process of claim 1, wherein an adhesive is used to apply the label to the shaped body.

5. The process of claim 1, wherein the shaped body produced in step a) is delivered to the filling step b) on a conveyor belt travelling at a speed of 0.01 to 1 m/s.

6. The process of claim 5, wherein the conveyor belt is travelling at a speed of 0.02 to 0.5 m/s.

7. The process of claim 6, wherein the conveyor belt is travelling at a speed of 0.03 to 0.3 m/s.

8. The process of claim 7, wherein the conveyor belt is travelling at a speed of 0.05 to 0.2 m/s.

9. The process of claim 1, wherein a plurality of shaped bodies produced in step a) are arranged on a tray and are subsequently filled b) at the same time and then sealed c) at the same time.

10. The process of claim 9, wherein at least four shaped bodies are arranged on the tray.

11. The process of claim 10, wherein at least six shaped bodies are arranged on the tray.

12. The process of claim 11, wherein at least ten shaped bodies are arranged on the tray.

13. The process of claim 12, wherein at least twelve shaped bodies are arranged on the tray.

14. The process of claim 9, wherein shaped bodies are filled in b) at a rate of 5 to 30 trays per minute.

15. The process of claim 14, wherein shaped bodies are filled in b) at a rate of 10 to 25 trays per minute.

16. The process of claim 15, wherein shaped bodies are filled in b) at a rate of 15 to 20 trays per minute.

17. The process of claim 1, wherein two or more labels are punched from a larger piece of film at the same time, held by vacuum, and applied to the shaped bodies after application of adhesive to the shaped bodies and/or to the labels.

18. The process of claim 17, wherein the adhesive is applied to the shaped body by roller.

19. The process of claim 17, wherein the adhesive is applied to the shaped body by casting.

20. The process of claim 17, wherein the adhesive is applied to the labels by roller.
